(19) United States
(12) Patent Application Publication
(10) Pub. No.: US 2006/0178954 A1
(43) Pub. Date: Aug. 10, 2006

(54) Iterative asset reconciliation process

(76) Inventors: Rohit Thukral, San Jose, CA (US); Constantin Stelio Delivanis, Los Altos Hills, CA (US); Alistair D'Lougar Black, Los Gatos, CA (US)

Correspondence Address: RONALD CRAIG FISH, A LAW CORPORATION, PO BOX 820, LOS GATOS, CA, 95032, US

(21) Appl. No.: 11/111,562

(22) Filed: Apr. 21, 2005

Related U.S. Application Data
(63) Continuation-in-part of application No. 11/011,890, filed on Dec. 13, 2004.

(51) Int. Cl. G06Q 10/00

(52) U.S. Cl. 705/28

(57) ABSTRACT

A multiphase matching process to reconcile imported asset records from a first legacy computer systems and inventory asset records which are either imported from a second legacy system or which are automatically discovered assets on a network of assets in a company or other entity by any automated asset discovery process. The multiphase matching process repetitively imports asset records, creates unique signatures for each to prevent duplication, and applies different techniques during each phase to automatically find matches, or provide tools to assist and operator to manually find matches and correct, complete or annotate asset records with incorrect or missing information and make new asset records for assets which have no asset records in the reconciliation database. Corrected, completed or new asset records can be exported through a reverse mapping processing into corrected, completed or new asset records in the original legacy computer systems.

### CROSS REFERENCE AND PRIORITY CLAIM TO RELATED APPLICATIONS

This application is related to the technology described in and is a continuation-in-part of U.S. patent application entitled SYSTEM FOR LINKING FINANCIAL ASSET RECORDS WITH NETWORKED ASSETS, Ser. No. 11/011,890, filed Dec. 13, 2004 (attorney docket BDN-006), which is hereby incorporated by reference.

### BACKGROUND OF THE INVENTION

Large companies have many expensive assets and many different computer systems to keep track of or help manage various aspects of the business. For example, the Information Technology department has one computer system in which computer assets are recorded in a first way to assist IT managers to manage the company's computer, router, printer and other assets used in the business. The chief financial officer has another financial reporting system which also keeps track of the assets of the business along with other things to aid the CFO to generate financial reports and assist outside auditors to audit the company's books and provide reports. Recent changes in the law require company officers to accurately report their assets and to swear that the reports are accurate.

Likewise, the accounts receivable and accounts payable departments will have their own computer systems to keep track of accounts payable and accounts receivable that result from transactions the company enters into. Likewise, the shipping and receiving department have computer systems which are used to track shipping and receiving transactions, some of which may involve receiving newly purchased company assets or shipping company assets to other locations or for service. Sometimes the hard assets of the company get entered in these systems as part of these transactions.

The data in these systems that describes the assets of the company are usually entered manually. This process is labor intensive and leads to inconsistent and incomplete and erroneous records. Human operators make errors, miss entries and fail to keep all these systems up to date. Having up to date, accurate computer records of the assets of a company is very important to proper accounting in a company and to accurate reporting of the financial condition of the company.

For accurate reporting, an up to date, accurate set of records in all the systems in the company which report assets is necessary. To reconcile all those records from different computer systems manually is very difficult and time consuming. Furthermore, as soon as the reconciliation was finished, it is out of date. Then, as new assets are added, they are not reconciled and the complete collection of records of corporate assets in the company's computer system is not reconciled.

Accordingly, a need has arisen for a computerized system to aid in the reconciliation process and which improves the degree of reconciliation achievable and the speed with which it can be done.

### SUMMARY OF THE INVENTION

A reconciliation process claimed herein is a multistep, iterative process wherein the degree of reconciliation is improved at each step. Records regarding assets a company has gathered from disparate sources need to be reconciled. A process to reconcile the asset records uses multiple iterations and multiple stages at each iteration. Each stage uses a different methodology to reconcile records from different sources. Each time a match is found, linking data or pointers are added to forever link the asset records from the different systems as referring to the same asset. The asset records to be reconciled are then reduced to remove the asset records that have been linked or reconciled successfully so that the next round of reconciliation has fewer records to deal with.

In general one can reconcile records from any number of enterprise systems using the system of the invention. In particular, one can define rules for two-way or three-way reconciliation. In two-way reconciliation, one can match inventory asset records with either the fixed asset records from a financial reporting computer system, or with legacy asset records from an IT asset management system. In general, “inventory asset records” or “inventory” or “inventory records” as those term are used herein means either asset records generated by a script driven server which automatically discovers assets on a network, or asset records which have imported from some legacy computer system. The preferred embodiment uses inventory asset records which are automatically discovered since that reduces manual date entry errors in the inventory asset records. However, the reader should understand that whenever the terms “inventory asset records” or “inventory” or “inventory records” or “automatically generated asset record” are used, those asset records could be asset records imported from some legacy computer system which could be either manually generated or automatically discovered using any automated asset discovery system. One could also use the system to directly reconcile legacy asset records from a legacy financial fixed asset system with legacy asset records from an IT asset management system. In three-way reconciliation you can reconcile inventory asset records with records from the IT asset management systems and also with records from the legacy fixed asset system.

The detailed descriptions below assume two way matching between legacy asset records imported from one of the legacy asset systems and inventory asset records also called automatically discovered asset records. However, the teachings of the invention can be applied equally well to matching asset records from two different legacy computer systems or three way matching between inventory asset records and legacy asset records from two different legacy computer systems.

### BRIEF DESCRIPTION OF THE DRAWINGS

FIG. 1 is a diagram showing how a robot process running on a server is used to automatically populate an asset database with specific information.

FIG. 2 is a block diagram of a typical computing environment in which the invention is practiced.

FIG. 3 is a diagram showing this process of gathering records from various systems and preparing them for reconciliation.

FIG. 4 is a pseudo flow diagram showing the various phases of the multiphase matching process and how they are performed one after the other and report exceptions to the next phase and report matches to a match linking process.

FIG. 5 is a block diagram illustrating the environment in which the automatic asset discovery process works and some of the key elements of a script-driven server to automatically inventory assets connected to a network and discover and store attributes about each one.

FIG. 6 is an example of the element/attribute data structure which defines the elements and defines the attributes of each element with semantic data and format data.

FIG. 7 is an example of a containment table which defines the system and subsystem relationships within the automatically discovered asset data.

FIG. 8 is an example of a user defined correlation table which defines which attribute data combinations a user wants views, graphs or other visual widgets of on her display.

FIG. 9 s an example of a collected data table which is the location where the collector processes store the instances of collected data.

FIG. 10, comprised of FIGS. 10A, 10B and 10C are a flowchart of an exemplary process of collecting data from the financial reporting system and the automatic discovery process of inventory of assets on the networks and reconciling them using exact matching rules and creating linkage data which links matched records.

FIG. 11 is a screen shot of a typical starting point for phase one matching in the multiphase matching system of the invention after the assets on the client's networks have been automatically discovered (the so called “inventory” assets) and some fixed assets have been entered into the system manually. It also shows some assets which have been entered using entries in the IT asset management system, from purchase recquisitions, purchase orders, receipts and invoices.

FIG. 12 is a screen shot of a typical list of fixed assets imported from the financial systems of a corporation into the asset reconciliation and linkage system the processing of which is shown in the flowchart of FIG. 10.

FIG. 13 is a screen shot of a rule definition screen where automatic exact matching rules can be defined for use in phase one matching to match assets imported from the legacy computer systems to automatically discovered assets found in inventory on the networks by the automatic discovery process.

FIG. 14 is a screen shot showing the results of application of the phase one exact matching rules to the fixed assets imported from the legacy system and the automatically discovered asset records in the reconciliation database for assets found in inventory on the networks.

FIG. 15 is a screen shot of a screen of unmatched fixed asset records (exceptions from the first phase of matching) which have been imported from a legacy system for which the automatic matching rules did not find a match among the automatically discovered asset records for assets in inventory discovered in the network by the automatic discovery process.

FIG. 16 is a screen shot of a screen wherein filter conditions are set to limit the number of unmatched fixed assets which will be examined manually in a manual search phase to attempt to find a match in inventory.

FIG. 17 is a screen shot of one embodiment of a user interface used in the manual search phase of the multiphase matching process showing fixed assets meeting the filter condition set in the screen of FIG. 16 and showing the unmatched automatically discovered asset records for assets in inventory from which a match may or may not be found.

FIG. 18 is a report screen shot showing the results of applying the matching rules and doing the manual reconciliation showing the number of reconciled assets, the number of unmatched fixed assets, and the number of unmatched inventory assets.

FIG. 19 illustrates a block diagram of a preferred embodiment of the current unique ID generation system in a network environment.

FIG. 20 is a flow chart illustrating steps of creating a signature according to specific embodiments of the unique ID generation system.

FIG. 21 is a flow chart illustrating steps of using matching rules to compare data elements according to specific embodiments of the signature generation system using other values as signatures.

FIG. 22 is a screen shot of a system suggested matching page display resulting from application of fuzzy matching rules.

FIG. 23 is a screen shot of the preferred embodiment for a user interface for manual search-based matching displays and tools which can be used to do further matching using manually generated searches.

FIG. 24 is a screen shot of the type of user interface tools that are presented to the user for entry of data during the manual data entry process 337 shown in FIG. 4.

FIG. 25 is a screen shot of a typical user interface used for entering new asset records.

### DETAILED DESCRIPTION OF THE PREFERRED EMBODIMENT

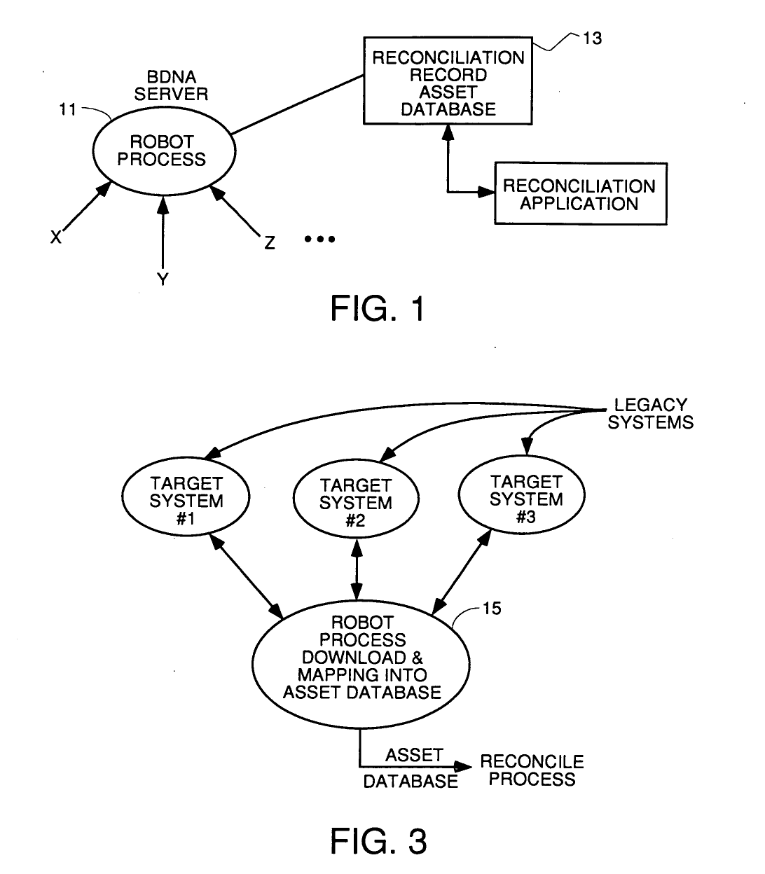

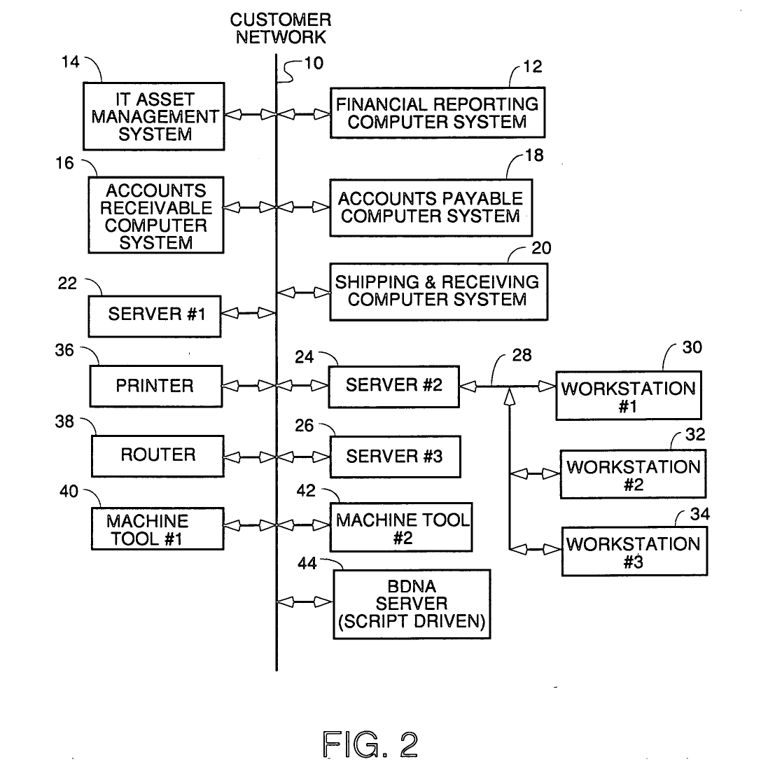

FIG. 1 is a diagram showing how a robot process running on a server is used to automatically populate an asset database with specific information. A server 11 (referred to herein as the BDNA server) running a robot data collection process collects information about assets a company has from various sources designated X, Y and Z in FIG. 1. There can be less than three or more than three sources of information about assets. These sources include such systems as the financial reporting computer system of the company used to prepare financial reports (12 in FIG. 2), the Information Technology (IT) asset management system used by the IT department (14 in FIG. 2), the accounts receivable computer system (16 in FIG. 2), the accounts payable computer system (18 in FIG. 2), the shipping and receiving computer system (20 in FIG. 2), and, in some embodiments, a separate server 44 which automatically collects information about assets on a network and the attributes thereof. The server 44 which automatically collects information about assets on a network will be called the script driven server. In the preferred embodiment, the script driven server 44 in FIG. 2 and the BDNA server 11 in FIG. 1 are the same server.

The script driven server 44 is described in more detail in a prior U.S. patent application entitled APPARATUS AND METHOD TO AUTOMATICALLY COLLECT DATA REGARDING ASSETS OF A BUSINESS ENTITY filed Apr. 18, 2002, Ser. No. 10/125,952 (attorney docket BDN-001), published as US2003-0200294 A1 on Oct. 23, 2003, which is hereby incorporated by reference or successors thereto or competing products which are essentially equivalent. The script driven server collects data at least about “elements” on the network. Elements may be servers, printers, routers, terminals, personal computers, numerically controlled machines, FAX machines, etc. An element can be anything connected to the network or even a lease, a license, or other tangible and intangible assets of the company. Each element has attributes such as CPU speed, amount of memory, number of CPUs, hard disk capacity, operating system manufacturer and version etc. These attributes uniquely define each attribute. In the preferred version of the script driven server 44, each element of a particular type has a uniform data structure. Each element data structure also has uniform attribute data structures which include the semantics regarding what the attribute is, a definition of what type of data can be used to fill in the attribute field, and a pointer to a script or collection instruction that can be used to retrieve the data about the attribute to fill in the data record.

FIG. 2 is a block diagram of a typical computing environment in which the invention can be practiced. A local area network 10 couples a plurality of computing systems and other electronic assets which the customer uses in carrying out its business. A financial reporting system 12 is used by the Chief Financial Officer and his employees to store and process data regarding the assets and liabilities of the company, keep track of the company bank accounts, etc. An IT asset management system 14 is used by the Information Technology Management group to record data about the computing assets the company has and manage those assets.

An accounts receivable computer system 16 is used by the accounts receivable department to track billing transactions and manage accounts receivable owed to the company. An accounts payable system 18 is used to track transactions with vendors and the amounts owed by the company to other entities.

A shipping and receiving computer system 20 is used by the shipping and receiving department to track shipments by the company to other entities and to track shipments received by the company such as new servers, machine tools, etc. which the company acquired.

The company used in this example also has three other servers 22, 24 and 26 used for various things such as engineering, simulation, computer aided design, drafting of engineering drawings and data entry of test data. Server 24 is coupled by a subnetwork 28 to a plurality of workstations 30, 32 and 34. The company network is also coupled to a shared printer 36 and router 38 and two two machine tools 40 and 42.

The first step before the reconciliation process of the invention can start involves a prior art process of automatically discovering the assets on a company's network and attributes thereof. This automatic asset discovery process is a function carried out by the BDNA server 44 in FIG. 2 or it can be carried out by the robot process in server 11. A detailed description of such a process is contained in a U.S. patent application entitled APPARATUS AND METHOD TO AUTOMATICALLY COLLECT DATA REGARDING ASSETS OF A BUSINESS ENTITY, filed Apr. 18, 2002, Ser. No. 10/125,952, (attorney docket BDN-001), published as US2003-0200294 A1 on Oct. 23, 2003 which is hereby incorporated by reference.

In general, the script driven server 44 functions to explore the IP addresses on network 10 to determine which IP addresses are owned by devices which are active. The script driven server then determines what type of device and what type of operating system is being run by a device that owns an IP address that has been determined to be active. Once the operating system is determined, the automated asset discovery process then executes one or more scripts that control the script driven server to determine the attributes of the asset. For example, scripts will be run which cause the automated asset discovery process to determine the attributes of servers 22, 24 and 26, printer 36, router 38 and machine tools 40 and 42 and workstations 30, 32 and 34. This attribute data for each asset is then post processed and stored in database 13 in a portion thereof reserved for records pertaining to “inventory assets” which are typically asset records for assets which have been automatically discovered on the network.

Elsewhere herein, these inventory asset records are referred to as automatically discovered asset records, but the reader should understand that these inventory assets need not always have been automatically discovered from the networks. In some embodiments, the inventory assets may be imported from some other legacy computer system than the computer system from which the fixed asset records were imported. These inventory asset records could have been manually generated on the other computer system or automatically discovered using any automatic asset discovery process run by the other computer system. Because the automatic asset discovery process is the preferred way of generating these inventory asset records, hereafter references to inventory asset records or automatically discovered asset records or the automatic asset discovery process may refer to these inventory asset records as having been automatically discovered from the networks, but the reader should understand that they may also have been imported from another computer system. No further attempts to point out these alternative embodiments will be made herein, and subsequent references to automatic discovery of asset records should be understood as including importing inventory asset records from another legacy computer system.

In the asset database 13, for each different type of asset, there are attribute records which have predefined fields which collectively define and give the semantics or meaning of all the different items of information, i.e., attributes, that might be of interest about a physical asset.

This automatic asset discovery process uses a uniform data structure for elements on the network and attributes thereof. Each data structure defining the semantics and data type that can be used to fill in each attribute data record also including a pointer to a collection instruction to drive the server to automatically collect the pertinent attribute data. This process to automatically collect information about assets on the network and attributes about them uses scripts executed by the server 44 or the server 11. These scripts cause the server to log onto or contact servers, routers, printers, etc. on a company's network that have addresses and to extract information about these devices such as serial number, type of machine, attributes, etc.

The data gathered by the automated asset discovery process is stored in one area of the asset database 13 reserved for the automated asset discovery process.

Next, the robot process running on server 11 in FIG. 1 downloads the records regarding assets kept in the various computer systems of the company. The various input sources X, Y and Z represent the various computer systems such as the financial reporting system 12, the shipping and receiving system 20, the IT asset management system 14, etc. in FIG. 2. The collected asset data is post processed and stored in an asset database 13 with the records from each source stored in a portion of the database reserved for storage of records from the particular source.

In the preferred embodiment, the robot process on server 11 goes through a mapping process which maps fields in the asset records downloaded from the target legacy system to the corresponding fields in the uniform asset database 13. Corresponding field, as that term is used herein, means a field having the same semantic definition. For example, an asset record in a legacy system may have a field called Type which is semantically defined as data identifying the manufacturer of the asset. A uniform asset record data structure in the reconciliation asset record database may have a corresponding field called Manufacturer in which the identity of the manufacturer is recorded. The mapping process will take the data in the Type field of the legacy system record and store it in the Manufacturer field in a corresponding asset record in the reconciliation asset record database. Similar processing occurs for the other fields in the legacy system asset records. In other words, when an asset record pertaining to a server is downloaded from a target system such as the financial reporting system 12, the fields of the asset record are mapped to the corresponding fields of the pertinent element record in the asset database 13 so that the data from each field of the record downloaded or accessed from the target system gets put into the proper field of an asset record in the asset database 13. This process is repeated for each record gathered from each other computer system in the company which has records regarding the company's assets till all the records to be reconciled with the automatically discovered assets have been collected.

The mapping process makes the matching process easier to implement because the automatically discovered asset records created by the scripted server will have the same data structure as the legacy computer system asset records imported from the target systems.

However, in some embodiments, the mapping process can be eliminated and the matching process is smart enough to determine the semantic definitions of each field in an asset record and perform matching based upon the semantic definition using the raw asset records imported from the legacy systems.

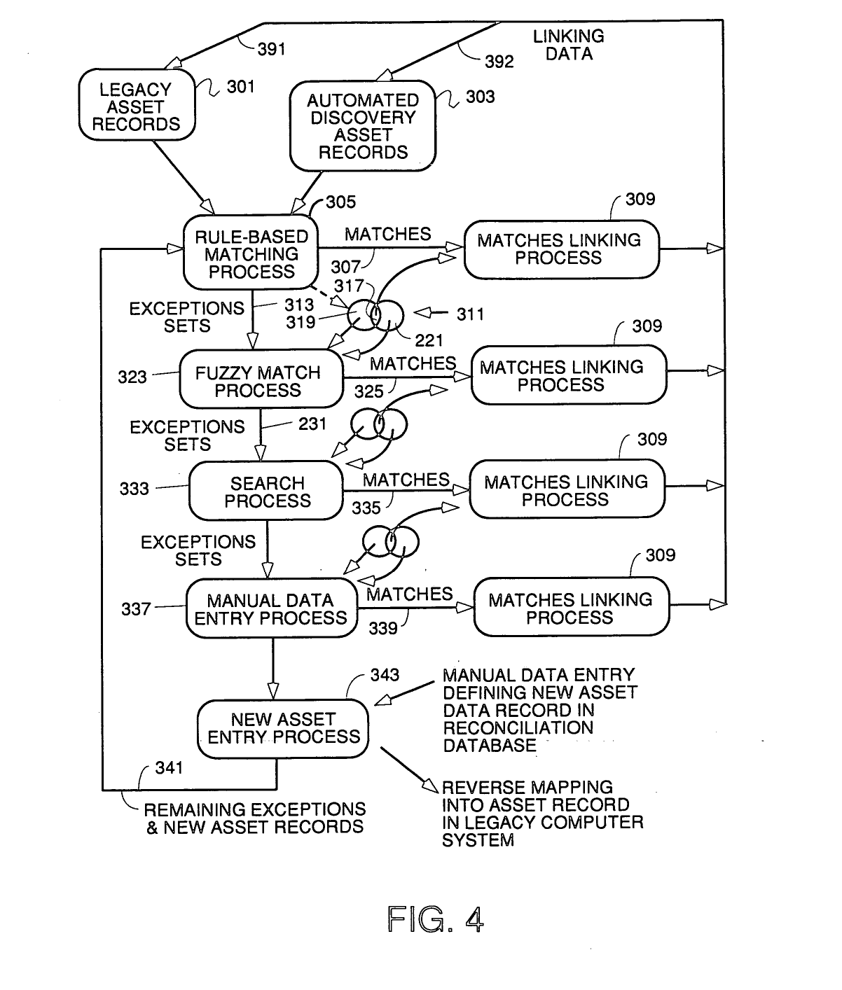

FIG. 3 is a diagram showing this process of gathering records from various legacy target systems and preparing them for reconciliation. The robot process of downloading records from the target systems #1, #2 and #3 and mapping the data therein into the uniform data structures in database 13 is represented by bubble 15. This is a straightforward semantic matching process to, for example match the manufacturer field in the target record to the make field in the uniform record in the asset database 13.

The robot process running on server 11 also uses the uniform data structure map data from asset records downloaded or entered in any other way from other systems in the company into the appropriate fields of element/attribute structures in the uniform data structure. This server 11 running the robot process can be the same server as the script driven server referred to above in the discussion of FIG. 1. In some embodiments, server 11 runs what is referred to herein alternatively as the automated asset discovery process as part of the robot process. This process automatically discovers assets on the network(s) of the client company and creates inventory asset records in some embodiments, and imports asset records from another computer in the companay in other embodiments.

After the data regarding which assets are on the network and the attributes of each is automatically discovered, and the robot process downloads records from the other computer systems in the company, the collected data is post processed to make sure it conforms to the data type definitions in the element/attribute data structures.

These asset records collected from the other computer systems in the company will be stored in separate areas of asset database 13 so that they can be reconciled against each other and against the records gathered by the automated asset discovery process. It is this collection of disparate records from different sources and which refer to the same physical assets that must be reconciled.

Asset records from each different source can be stored in tables, one table for each source, or in separate databases. If records from different databases or different tables are found by the reconciliation process to correspond to the same physical assets, pointer data can be added to a pointer field in the appropriate rows of the appropriate tables pertaining to records to be linked which forever links the records in different tables as referring to the same physical asset. Likewise, in alternative embodiments, fields in the appropriate records of the appropriate databases can have pointer data stored therein which forever links the different records from the different databases as pertaining to the same physical asset.

The Multiphase Reconciliation Process

Reconciliation of records from the different sources of information about the assets of a company both lowers the need for reserves on the books for accounting purposes, and enables better compliance with new rules of accountability for top executives of companies with regard to accurate reporting of the company's financial position. Manual data entry of asset records is time consuming, error prone to operator error and continually out of date. Asset management in a company, for example, entails keeping track of what assets have been purchased and where they are. In contrast, financial reporting has different ends such as keeping track of life cycles of assets and which assets are still in use in various entities within a company. Different computer systems are used for these different purposes, and the records kept in each have different structures. Further, the asset records entered in the various computer systems in a company are entered manually, so this often leads to errors and inconsistencies between records regarding the same asset entered by different operators into different computer systems in the same company.

It is important to have at least a semiautomated system to enable rapid, cost effective reconciliation of records from different computer systems in the company so as to be able to have an accurate picture of the assets of a company and to be able to maintain that accurate picture over time.

In the prior art, reconciliation of asset records was carried out manually, and this was time consuming and impossible to reconcile every asset in large corporations. This led to sampling and the need for reserves on the books.

An improvement on the manual reconciliation process is a semiautomated reconciliation process described in U.S. patent application entitled SYSTEM FOR LINKING FINANCIAL ASSET RECORDS WITH NETWORKED ASSETS, Ser. No. 11/011,890, filed Dec. 13, 2004 (Attorney docket BDN-006). This technology is part of the first phase of the multistep reconciliation process according to the teachings of the invention.

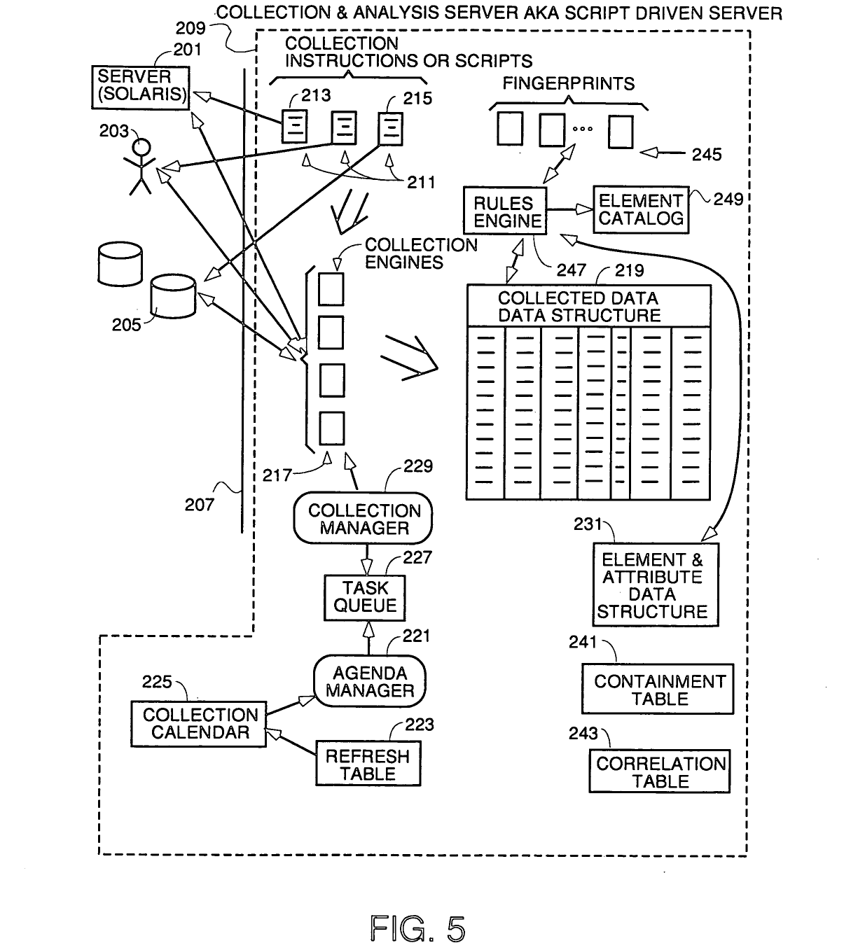

An overview of the multiphase reconciliation process is shown in FIG. 4. The basic idea is to attempt to match asset records from different sources in each phase using different techniques and to generate linking data for matches found. Then the records not matched are sent to the next phase for further matching attempts using different techniques and linking data is generated for any additional matches found. Then the records still not matched are sent to the next phase for further attempts at matching. This process is repeated, usually periodically.

In FIG. 4, 301 are the asset management records collected from the various computer systems in the company. In this embodiment, all those asset records can be collected in one table or database and compared only against the asset records 303 collected by the script driven server in the automated asset discovery process. In alternative embodiments, the asset records collected from each different computer system are stored in different databases or tables and the process of FIG. 4 is carried out for each combination of two different sources of asset records.

Overview of the First Phase

The first phase of matching is carried out in a rules-based matching process 305. Matching rules are used to find matches between “automatic discovery asset records” and “legacy asset records”.

The “automatic discovery asset records” are asset records in the reconciliation database which define assets that have been automatically discovered on the network by the script driven server. These “automatic discovery asset records” are uniform data structure records generated by the script driven server from attribute data discovered about the asset to which they pertain. As new assets are acquired and connected to the network, they are discovered by the automated asset discovery process described elsewhere herein. Any attributes which are undiscoverable by the automated system because they are not recorded in the asset itself can be manually entered using user interface tools presented to the user which, when invoked, have the capability to add data to or correct data in either an automatic discovery asset record or a legacy asset record. Such undiscoverable attributes may include: asset owner (user name); asset number; serial number; cost center; purchase requisition number; purchase order number; vendor invoice number; purchase cost, lease term, lease payment, contract number, etc. Since most of the asset attributes are automatically discovered, data entry errors for those discovered attributes are eliminated. The new assets can be managed in the system of the invention itself, or populated back to the legacy computer systems.

The “legacy asset records” are asset records derived from asset records imported from the legacy computer systems and mapped into uniform records in some embodiments or are the asset records imported from the legacy system in other embodiments where mapping is not used.

In one embodiment, the matching rules for the first phase are manually written. In another embodiment, the matching rules are generated automatically during the mapping process that was used to import the records gathered from the legacy computer systems into the uniform data structure of the records in the reconciliation database 13 in FIG. 1. Each matching rule is applied to each pair of records with one member of the pair being an automatically discovered asset record (that terminology also applies to asset records imported from another computer system) and the other member of the pair being an uniform data structure asset record mapped from a record imported from a legacy computer system. The way in which these matching rules are applied to the asset records is not critical to the invention. For example, one rule can be first applied to every pair in the set, and then the next rule is applied to every pair of unmatched records in the set that remain. In another embodiment, all matching rules may be applied to all possible pairs simultaneously or separate matching processes, one for each rule can be simulataneously operating against all possible pairs.

Matches are represented by line 307 as reference to a matches linking process 309 where pointers between records from different systems are generated. In the preferred embodiment, manual confirmation is requested for every proposed match before linking data is created.

To create the linking data, typically, the asset records which are automatically discovered are stored in tables with one row per asset and a number of columns equal to the number of attributes recorded about that asset plus a column for pointer or linking data. The linking data links the record to another record in a different table of uniform data structure asset records generated from asset records imported from a legacy computer system. When a match between two records is found, pointer data is added to the table entries for those two records to point to the other record as a match. The same thing can be accomplished with database entries by using a field in each database entry in which to record pointer data. The linking data is written into the asset records in the tables or databases 301 and 303 for the legacy asset records and the automated discovery asset records, respectively, as symbolized by lines 391 and 392.

Each asset record which is imported from a legacy system or which is generated by the script driven server during the automatic asset discovery process has its attributes combined to generate a unique signature for that asset record. Each time the automatic discovery process or importation process is performed anew (such as the periodic re-running of the entire reconciliation process), the signatures generated for each such record are the same as were generated in previous rounds of the reconciliation process. The signatures generated for the imported asset records and the automatically discovered asset records are compared to signatures of asset records previously placed in the reconciliation database to determine if the asset record is already present in the reconciliation database and has been previously matched. If the signature of an asset record is not found in the reconciliation database, the asset record is added to the database and subjected to further matching efforts.

After conducting the rules based matching process, exceptions (unmatched records) are sent to the next phase, as represented by line 313. In the set diagram at 311, the matches are represented by intersection set 317 and the exceptions or unmatched records are represented by 319 and 321 (the original sets minus the matched records intersection set). Exception reports can take the form, for example, “record A from the IT computer system was matched to record B from the accounts receivable system, but no record corresponding to the same asset was found in the accounts payable system or the automatic discovery asset records.”.

In the preferred embodiment, proposed matches triggered by the matching rules are manually presented to the user for verification, and the user can verify each match manually or verify enough matches manually to develop a level of confidence that the matching rules are doing a good job and then accept the rest of the matches en masse.

Also in the preferred embodiment, user interface tools are available during all phases which can be used by a user to correct or annotate records of a match. In some embodiments, these tools can be used to edit or annotate records which are not part of a match such as exception records. Thus, for example, if there is a known discrepancy in manually entered data of a matching record which is apparent from the automatically discovered asset record, these tools can be invoked to actually correct the data in the uniform data structure record derived from the imported legacy system record or to annotate a field with an annotation to suggest a change to the data in the field to which the annotation is attached.

User interface tools which can be invoked by an operator to correct mistaken data or add missing data or annotate data in asset records are presented to the users of the system at every phase.

Exceptions are unmatched records after the processing of a phase has been completed. Exceptions are sent to the next phase process for further attempts as matching. This happens at every phase.

Overview of the Second Phase

The second phase matching process 323 uses the records defined by the exception report from the first phase and uses some different technique to attempt to find further matches. Preferably this other technique is use of fuzzy matching rules based matching where a match can be declared or proposed between two records from different sources where there is substantial overlap but not complete identity between the attributes of different asset records. Sometimes, a serial number of manufacturer name may be slightly off or missing altogether, and this prevents the exact matching rules from making a match between two records from different systems pertaining to the same asset. For example, an automatic discovery asset record and a legacy asset record may match in all fields except that the legacy asset record is missing a serial number or the manufacturer is missing, misspelled or abbreviated. The fuzzy matching rules can remedy this problem by displaying proposed matches ordered by the degree of closeness of the match and allow an operator to select the correct match. User interface tools can then be used to annotate a legacy record with incorrect information or to add missing information such as the missing serial number to a legacy asset record.

In the preferred embodiment, fuzzy matching rules are used to develop a set of proposed matches between an automatically discovered asset record and legacy asset records derived by the mapping process from asset records imported from the legacy computer systems (or vice versa in other embodiments). In the preferred embodiment, the proposed matches are ranked by their closeness, and are displayed to a human operator.

The proposed matches can be inspected by the operator to determine if any of them are actual matches. If one or more matching records are found, the matching records are sent to the match linking process 309, as symbolized by line 325. There, linking data is added to the matching records in the reconciliation database to link the matching records together. These matches are maintained and not overwritten by the next round of importation of records from the legacy computer systems and the next round of automatic discovery of asset records. Overwriting is prevented through the use of unique signatures developed from the attributes of each record. Unique identifiers or signatures are assigned to inventory asset records by the script driven server when asset records are created by the automated asset discovery process. Legacy Asset records (also called fixed asset records herein) that come from or are derived from a legacy system asset record have their own unique identifiers assigned by the legacy system. After an inventory asset record is matched to a legacy asset record, the BDNA asset record reconciliation system according to the teachings of the invention maintains a link between the inventory asset record and the legacy asset record. These signatures will be the same each time the asset is discovered on the network or a legacy asset record is created from an asset record imported from a legacy computer system. Before a new legacy asset record or a new automatic discovery asset record is stored in the reconciliation database, its unique signature is generated from its attribute data and the signature is checked against the unique signatures of legacy asset records and automatic discovery asset records already stored in the reconciliation database. If an asset record with the same signature is found in said reconciliation database, it is not overwritten with the new legacy asset record or the new automatic discovery asset record. This prevents matches which have already been made from being overwritten.

If the proposed matches are rejected by the operator, the unmatched records are reported as exceptions to the next phase process as are all other unmatched asset records.

Overview of the Third Phase

The third phase matching process is a search based matching process 333 which can be used on exceptions from the previous phase. In this phase, user interface tools are provided to a user at a workstation to allow the user to set up search criteria to search for a matching asset record from a second source based upon information the user views from an asset record from a first source. In some embodiments, a record from the automatic asset discovery process can be used to generate the search criteria to search records derived from asset records imported from legacy systems. In other embodiments, legacy asset records derived from asset records imported from legacy system are the basic asset record for which a search to find a match amongst the automatically discovered asset records is composed. In other words, a the legacy asset record without a match is used to give the operator ideas for keyword searches to find the automatically discovered asset record created by the scripted server in the automatic asset discovery process which pertains to the same asset.

The search may return asset records. These asset records can be viewed by the operator, and if one is recognized as a match, that record is selected and the two matching records are reported to the linking process where linking data is added to each asset record to link the two together in the reconciliation database.

Some legacy asset records will remain unmatched after this search and match phase. Some of these unmatched records or exceptions may be unmatched because the data imported from the legacy system was incomplete or incorrect. The fourth phase process provides tools to correct such errors, so the exceptions are passed to the fourth phase.

The search tools and the data correction and annotation tools are available for use by the user in all phases of the multiphase matching process in the preferred embodiment.

Overview of the Fourth Phase

The fourth phase matching process is a manual data entry process 337 which provides tools a user can use to browse records in the asset database to look for legacy asset records with missing or incorrect information and correct it or annotate it with the proposed correct data. These tools can also be used to send a request to the department where an asset is located requesting return of correct information about an asset. For example, suppose some legacy asset records were derived from asset records in legacy systems where tag number or serial numbers had not been entered or were entered incorrectly. The lack of serial numbers will prevent the exact matching rules from finding a match among these records. The tools available to the user can be invoked to enter the correct serial numbers in the legacy asset records if known or to send requests to the department where the assets are located asking that the serial numbers be returned. The corrected legacy asset records will usually then be matched by the exact matching rules the next time the first phase matching process is performed on the asset records in the reconciliation database. Annotations are useful because the original data is not lost and can be referred to.

In one embodiment, the user interface correction tools includes a markup tool to strikeout incorrect data in a field of a legacy asset record while still showing the stricken data and adding new corrected data to the field. After review and verification, a command can be given to accept the changes and the new data will become the data stored in the field.

In some embodiments, the manual data entry/tools are provided to correct legacy asset records in said reconciliation database which are derived from asset records imported from the legacy systems. This is done after these legacy records have been matched using the rule-based matching process 305, the fuzzy match process 323, and the search and match process 333.

In other embodiments, the tools can be used to mark up data in fields of asset records like the track changes capability of Microsoft Word, and then a command can be given to accept changes to replace or correct data in fields that have been marked up. The corrected data or added data will then be accepted as the new data stored in the fields which have been marked up.

The manual data entry tools can be used to look at legacy asset records that have been linked to records which have been created from the automatically discovered asset records pertaining to elements connected to the network. In some embodiments, any information that is missing or incorrect as determined from inspection of the attribute data which was automatically discovered can be corrected in the legacy asset record derived from an asset record imported from the legacy system.

In other embodiments, any information which is missing or incorrect in a legacy asset record derived from an asset record imported from a legacy system can be simply annotated noting the necessary corrections using the tools provided in this fourth phase. Then these annotated records can be passed back to the department which uses the asset to which the legacy record pertains so that operators there can make manual corrections to the records in their legacy computer system. If some information is missing which cannot be determined from the automatically discovered attribute data, a tool is provided to communicate to the department where the asset is located to make a request for the missing information.

In other embodiments, the manual data entry phase provides tools which can be used to browse through and correct, markup or annotate legacy asset records derived from asset records imported from legacy systems which have not been matched with a record of attributes of an element that has been automatically discovered. A command can then be given to export the corrected record. This causes the corrected record to be reverse mapped into a corrected asset record in the form it was imported from the legacy computer system. This corrected asset record is then exported to the legacy computer system for storage.

In all the above described embodiments, if matches become apparent while manually correcting or annotating data records, these matches are reported to the match linking process 309, as symbolized by line 339. Also, the corrected asset records that have not been previously matched can be reported as exceptions to the phase 1 rules-based matching process 305, as symbolized by line 341. These corrected, unmatched records are then subjected to the rule-based matching process 305, the fuzzy match process 323, and the search and match process 333 again to see if a match results, and, if so, the matching records are reported to the match linking process 309 to establish linking data to link the records imported from the legacy system with records created by the script driven server for assets which are on the network and which have been discovered by the automatic asset discovery process.

New Asset Entry Phase

A new asset entry phase 343 is a phase in which user interface tools are provided which a user can invoke to create new asset records in the reconciliation database for assets which have been newly acquired. A user of the invention manually enters data defining the attributes of the newly acquired asset in a uniform data structure record in the reconciliation database. After the record is created, it can be exported to a legacy computer system via the reverse mapping process to create a correct asset record in the legacy computer system where the asset should be reported. The customer can configure the system of the invention to automatically export the newly created asset records or corrected asset records created during the manual data entry stage back to the legacy computer systems or to generate a report listing the assets so that asset records in the legacy computer systems can be manually created or corrected using information on the report. In the preferred embodiment, this capability is provided through one or more user interface tools which can be invoked to selectively either automatically export the new or corrected asset records back to a target legacy system or create a report which lists the new and/or corrected asset records for use by the operators of the legacy computer system to create new asset records or correct existing asset records in the legacy system. Any remaining exceptions (including legacy asset records which have been corrected) and any new asset records created in process 343 are used as input 341 into the phase one rule-based matching process 305 for the next iteration where the multiple phases of matching described above are executed again on the exceptions and any new asset records created from asset records imported from legacy computer systems and any new automated discovery asset records discovered by the automated discovery process.

### More Detailed Discussion of Each Phase

First Phase

The reconciliation process of the invention cannot begin until the automated asset discovery process is performed to generate the automatic discovery asset records. This process is carried out by the script driven server, and one example of it is given in detail in U.S. patent application Ser. No. 10/125,952, filed Apr. 18, 2002 which was published as US 2003-0200294 on Oct. 23, 2003 and which is hereby incorporated by reference. The highlights of this process are given below. Any process which can automatically explore a network and discover the assets connected to it and their attributes will suffice to provide the automatic discovery asset records.

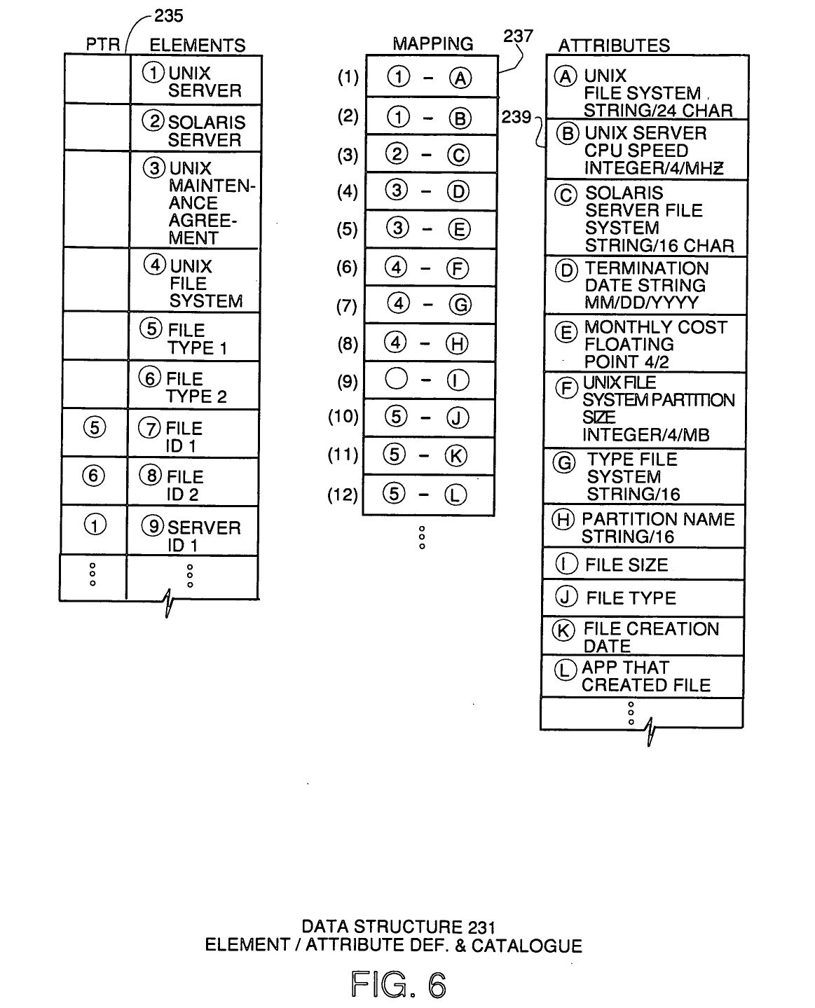

Referring to FIG. 5, there is shown a block diagram illustrating the environment in which the automatic asset discovery process works. FIG. 5 illustrates schematically the most important elements of a system which can automatically retrieve attribute data about the assets of an entity and determine from this data the makeup or DNA of the organization. In other words, a system like that shown in FIG. 5 can automatically determine the number and type of computing hardware assets, and installed software, as well as key elements of information about the organization and extracted key information from the organization's leases, contracts, licenses, maintenance agreements, financial statements, etc. Essentially, all the important information that defines the makeup or “genes” of a business organization or government can be automatically gathered and assets automatically identified from their attributes. This information can be periodically re-gathered to present an up-to-date picture of the makeup of an organization to management at substantially all times.

The sources of data from which information is to be collected in this particular organization are server 201, person 203 and file system 205. All these sources of data are connected together by a data path such a local area network (LAN) 207 (which can be fully or partially wireless) and suitable interface circuitry or, in the case of a human, a workstation including a network interface card and an e-mail application.

Everything to the right of LAN 207 represents processes, programs or data structures within a collection and analysis server 209, also known herein as a script driven server, which implements the process of automatically discovering the assets on a network and the attributes thereof.

A set of collection instructions or scripts, indicated generally at 211, are definitions and programs which serve to define what types of information can be gathered from each source and methods and protocols of doing so. For example, collection definition 213 may be for a server running a Solaris operating system and may define that one can get files, file systems mounted and processes currently in execution from such servers and the way in which to do so such as by invoking one or more specific function calls of an application programmatic interface of the operating system. Collection definition 215 contains instructions on how to extract attribute data file system 205. The collection instruction contains data on how to extract from the file system 205 attribute data about such things as the file system partitions, partition size, partition utilization, etc.

The collection definitions or scripts give specific step by step instructions to be followed by data collector processes, also referred to as collection engines, and shown generally at 217. These collector engines are processes in the collection server 209 which can use the scripts 211 to establish connections over existing protocols and data paths to the various asset data sources under the guidance of the scripts 211 and extract attribute data from each asset. These collection engines actually collect the desired information needed by the system to identify which assets are present and extract attribute information that management desires to see or to keep track of from the assets themselves, people and documents. The collection engines contain specific program instructions which control them to traverse the network and communicate with the data source using the proper protocols and invoke predetermined function calls, read predetermined files or send predetermined e-mails addressed to specific people to extract the information needed.

The collection engines 217 can be any processes which are capable of running the program instructions of the scripts 211. The collection engines 217 must be capable of communicating with the data source devices, people or processes identified in the collection instructions using the necessary protocol(s). Those protocols include the various software layers and network communication hardware interface or gateway coupled to the collection and analysis server 209, the network protocols of whatever data path 217 the communication must traverse and the protocols to communicate with the appropriate process at the data source such as the operating system for server 201, the e-mail program of person 203 or the appropriate process in file system 205. Any collection process that can do this will suffice.

In the preferred embodiment, the collection engines are generic prior art “scrapers” which have been customized to teach them to speak the necessary protocols such as TCP/IP, SNMP, SSH, etc. which may be necessary to talk to the various data sources in the system.

Each collection engine 217 is identical in the preferred embodiment, and they are assigned to data collection tasks on availability basis. Typically, all the common processing is put into the collection engines such as libraries or adaptors for the different protocols the collector might have to use such as TCP/IP, IP only, UDP, Secure Sockets, SNMP, etc. This way, the collection instructions need not include all these protocols and can concentrate on doing the steps which are unique to gathering the specific data the collection instruction is designed to collect. In alternative versions, only the protocol libraries necessary to gather the particular data a collection instruction is designed to gather can be included in the collection instructions themselves. In other versions, the protocol libraries or adaptors can be shared by all the data collector processes and just accessed as needed.

Typically, data collection requests are queued and as a data collector process, running locally or across the network, becomes available, it retrieves the next data collection request and the appropriate collection instruction for that request if it has support for the requested collection protocol. Then it executes the collection instructions therein to retrieve the requested data and store it in the appropriate location in a collected data storage structure 219. Alternatively, a single collection process can be used that has a queue of collection requests and processes them one by one by retrieving the appropriate collection instruction for each request and executing the instructions therein.

Collected data structures 219 serves as the initial repository for the collected data obtained by the collection engines. This is typically a table which has a column for storage of instances of each different attribute, with the rows in the column storing the value of that attribute at each of a plurality of different times. The intervals between the instances of the same attribute data vary from attribute to attribute, and are established by a refresh schedule in refresh table 32 in FIG. 1. Typically, all attributes are collected repeatedly on a “refresh schedule”, subject to a collection calendar that drives at which time and date collection shall take place. This allows analysis of how the value of an attribute changes over time.

An agenda manager process 221 consults the refresh schedule for each attribute in a refresh table 223 and also consults a collection calendar 225 to determine times and dates of collection of attributes. If this schedule data indicates it is time to collect an attribute, the agenda manager 221 puts a collection request in a task queue 227 for collection. A collection manager 229 periodically or continually scans the task queue 227 for tasks to be accomplished, and if a task is found, the collection manager 229 gets the task from the task queue 227 and retrieves the appropriate collection instruction for the requested attribute and executes its instructions using an available one of the collection engines 217. The collector then retrieves the data and stores it in the next available row of the column in collected data tables 219 that store instances of that attribute.

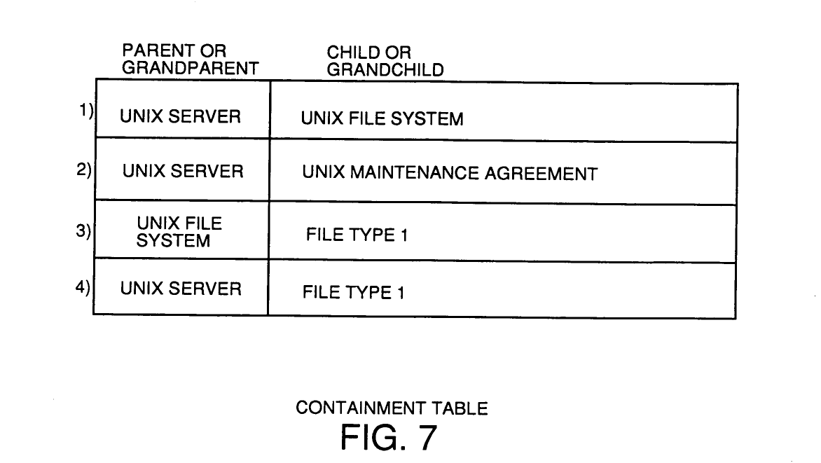

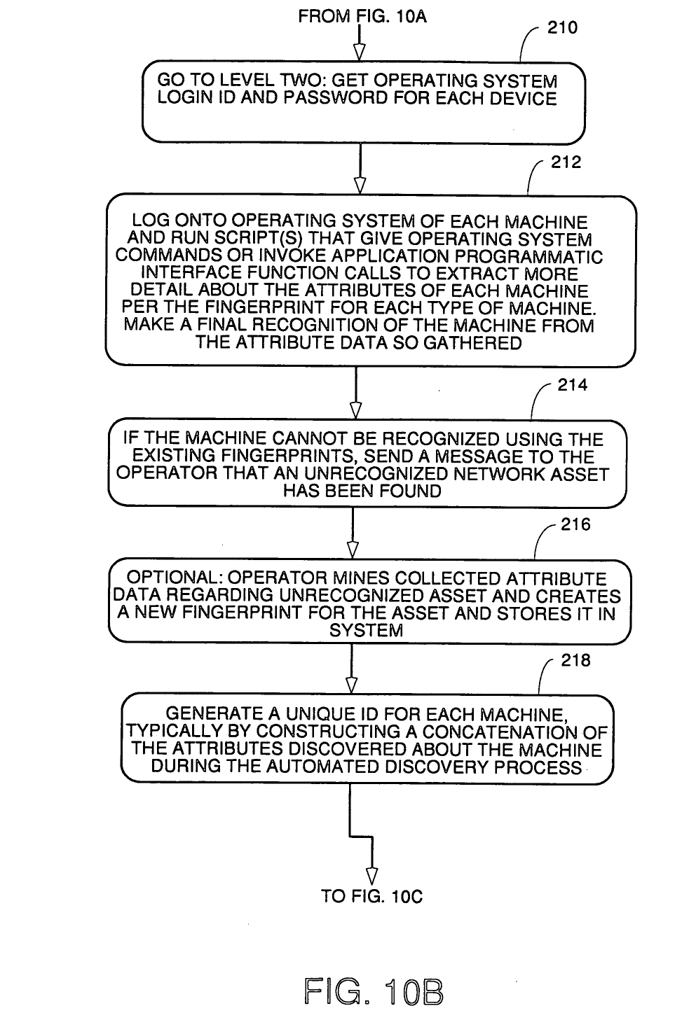

Each column in the collected data table is designed to receive only attribute data of the type and length and semantics defined for the attribute in an element/attribute data structure 231. In other words, each attribute has its instances stored in only one column of the collected data table, and the instance data must be in the format defined in the element/attribute data structure of FIG. 6. If the collected attribute data is not in the proper format, it is post processed to be in the proper format before it is stored in the collected data table 219. This makes it easier to write programs that deal with the collected data because the programmer knows that all instances of a particular attribute will have the same format. In FIG. 9, the semantics of the attribute stored in each column and format data which defines the type of data, length and units of measure defined in the element/attribute table of FIG. 6 are listed above the double line 233, and the actual attribute data instances for each attribute are stored in each column below the double line.

An element/attribute data structure 231 stores element entries for all the elements the system can identify and defines the attributes each element in the system has. The element/attribute data structure 231 also serves as a catalog of all the instances found of a particular element type. An example of an attribute/element data structure 231 is shown in FIG. 6. In the preferred embodiment, this data structure is comprised of three tables. The first table, shown at 235 in FIG. 6, has an entry for each element definition and an entry for each instance of an element that has been found by the system with a pointer to the element definition. For example, elements 7 and 8 are file instances that have been found with pointers to element entries 5 and 6, respectively. This means that the file which the system found and gave an element identification “File ID 1” is an instance of file type 1 defined by the attributes mapped to entry 5 in the element column. Likewise, the file instance found by the system and entered as an element at entry 8 is an instance of file type 2 defined by the attributes mapped to and which define the file element at entry 6. Likewise, the system found a server and assigned it “ID 1” and made an entry at 9 in the element table. This entry has a pointer to entry 1 indicating the server instance at 9 is a UNIX server defined by the attributes mapped to entry 1. Only instances of elements have pointers in pointer column, and these instances define the elements that have been found in the system. The elements with pointer entries are a catalogue of everything that makes up the company.

Typically, the element definition will be semantic data naming the element or telling what the element is. Each element has one or more attributes which are defined in a second table shown at 239. Semantic data and form data in each entry of this second table names the attribute defined by that entry or defines what it is and what form the attribute data is to take, e.g., floating point, integer, etc. For example, entry A in this table is an attribute named Unix file system. This name is a string of alphanumeric symbols 24 characters long or fewer. Entry B is an attribute named UNIX server CPU speed which will be an integer of 4 digits or fewer with units of mHz. Entry E is an attribute named monthly cost which will be a floating point number with 4 digits to the left of the decimal and 2 digits to the right. These definitions are used to post process gathered data to the format of the definition for storage in the collected data table 219. The third table, shown at 237, is a mapping table that defines which attributes in the second table belong to which elements in the first table. For example, attribute A in table 239 is an attribute of element 1 in table 235, and attribute D is an attribute of element 3. There are subsystem relationships that are inherent in the data structure of FIG. 6, but not specifically identified. For example, element 4 “UNIX file system“is actually an attribute of UNIX server element 1 in table 235, and is defined at entry A in table 239.

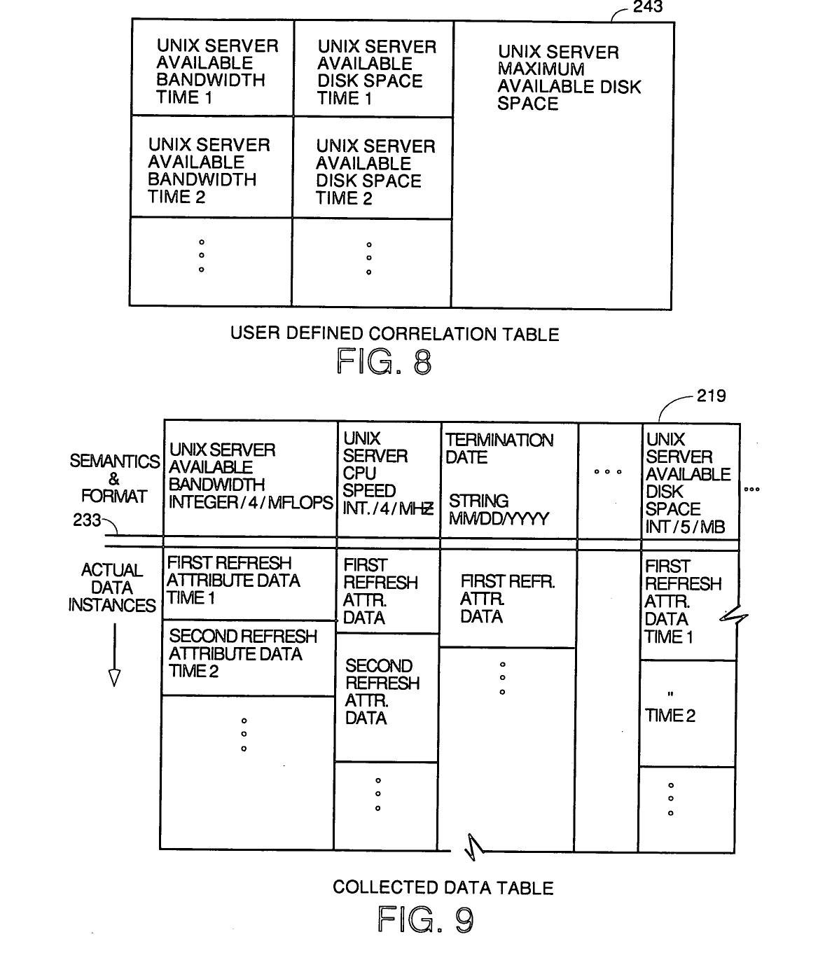

Every system may have systems and subsystems. A containment table 241 in FIG. 5, an example of which is shown in FIG. 7, defines which elements are sub-elements or subsystems of other elements. Row 1 shows that the UNIX server, element 1 in table 235, FIG. 6, has as a first subsystem or child element, the UNIX file system listed as attribute A in table 239 of FIG. 6 and element 4 in table 235. The UNIX file system itself is listed as an element in table 235 because it has attributes mapped to it by rows 6-9 of the mapping table 237 of FIG. 6. Specifically, the UNIX file system has as attributes the partition size, type of file system, and the partition name attributes defined at entries F, G and H in table 239. Row 2 of the containment table shows that UNIX file server element also has another subsystem which is the UNIX maintenance agreement defined at element entry 3 in table 235. The UNIX maintenance agreement has defined attributes D and E of table 239, i.e., the termination date and monthly cost. Row 3 encodes the parent-child relationship between the UNIX file system and a file type 1 element. Row 4 of the containment table encodes the grandparent-grandchild relationship between the UNIX file server and the file type 1 element.

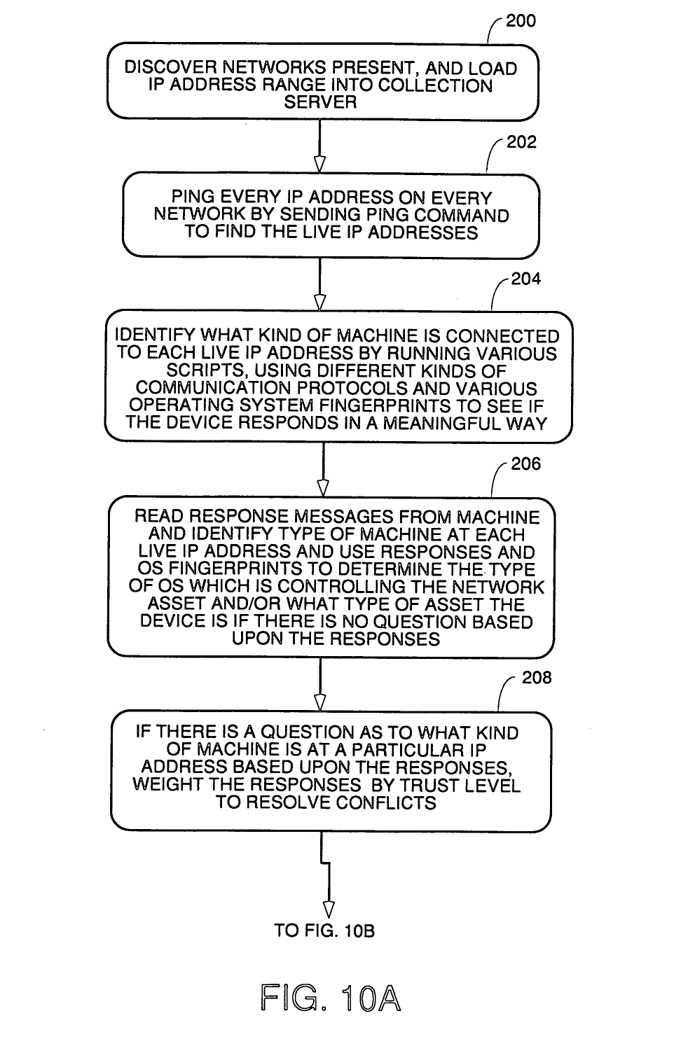

A correlation table 243 in FIG. 5 stores the attribute data that allows a user to see the relationships between different user selected attributes over time. An example of this table is shown in FIG. 8. The correlation table supports user defined visual interface “widgets” of different types such as graphs or juxtaposition views between different attributes as well as other functions. This allows the user to compare different attributes over time such as server utilization versus maintenance costs. The particular example illustrated by FIG. 8 supports a juxtaposed view widget comparing server bandwidth versus available disk space over time as compared to maximum available disk space on the server. The correlation table is an optional element and is not part of the broadest definition of the genus of the invention since the immediate value of the system is believed to be its ability to automatically gather attribute data, compare it to fingerprints, identify assets and automatically extract other important information management needs from documents, files and by sending messages to people who know the needed information.

Returning to the consideration of FIG. 5, once all the attribute data has been stored in the collected data table 219, a comparison process compares the attribute data to a plurality of “fingerprints” shown generally as the data structures 245. These fingerprints combine with the element/attribute definitions stored in data structure 231 illustrated in FIG. 6, to completely define the elements, i.e., systems and subsystems, the system of FIG. 5 is able to automatically detect. The element/attribute definitions in data structure 231 define what each element is and which attributes that element has.

The fingerprints shown at 245 are data structures which define rules regarding which attributes may be found for that element to be deemed to exist and logical rules to follow in case not all the attributes of an element definition are found. For example, some installs of software fail, and not all the files of a complete installation are installed. Other installations of suites of software allow custom installations where a user can install only some components or tools and not others. The fingerprints 245 contain all the rules and logic to look at the found attributes and determine if a failed installation has occurred or only a partial installation of some programs and/or tools has been selected and properly identify that asset to management. For example, if all the attributes of an Oracle database are found except for the actual executable program oracle.exe, the Oracle database fingerprint will contain one or more rules regarding how to categorize this situation. Usually the rule is that if one does not find a particular main executable file for a program, one does not have that program fully installed even if all its DLLs and other support files and satellite programs are found.

A rules engine process 247 uses the rules in the fingerprints and the definitions in the element/attribute data structure 231 as a filter to look at the collected attribute data in collected data table 219. If all the attributes of a particular element are found in the collected data, an entry in the element catalog data store is made indicating that the element is present. If only some of the attributes are present, the rules compare engine applies the rules in the fingerprint for that element to whatever attributes are found to determine if the element is a partial installation of only some tools or programs selected by the user or an installation failure and makes an appropriate entry in the element catalog 249.

More Details About the First Stage Exact Matching Rules Process

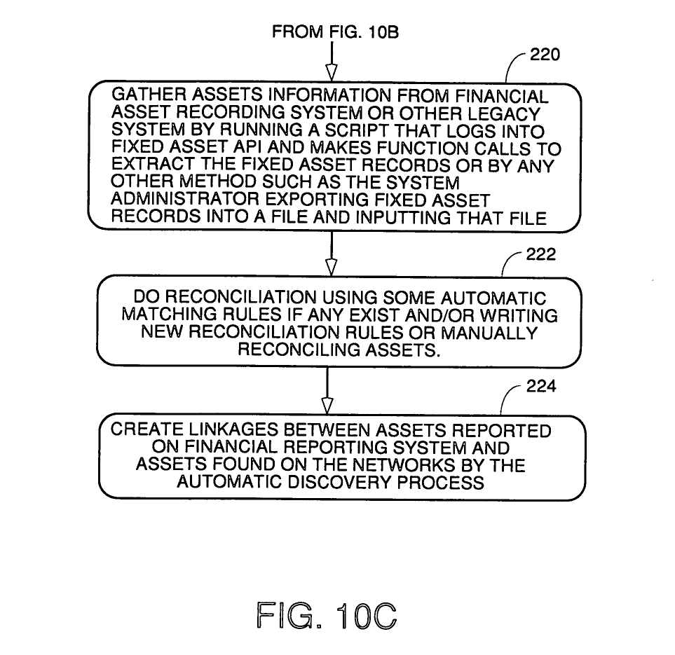

Referring to FIG. 10, comprised of FIGS. 10A, 10B and 10C, there is shown an overview flow diagram of one embodiment of a process to automatically gather data about the assets (elements) on a company's networks, assign them unique IDs and gather information about which assets are carried on a company's books and reconcile them with the assets found on the networks through the use of phase one exact match rules.

Step 200 represents any automated asset discovery process such as the class of processes described above. Another embodiment of such an automated asset discovery process is following scripts to discover the number and types of networks a company has, and then loading an Internet Protocol IP address range into the collection server. This IP address range will be the range of IP addresses that encompasses the company's network or networks. The reason this IP address range is loaded is so that the IP addresses in the range can be pinged to determine which addresses are active with some network asset behind it. Step 202 is the process of pinging every IP address in the range to determine which IP addresses respond in a meaningful way indicating a network asset with a network interface card is present.

A ping is a known command packet in the network protocol world. If a device at an IP address is live, it will respond with a certain pattern. If a device at an IP address is not active, it will respond with a different pattern. This process represents using the valid addresses of each discovered network and one or more network interface card fingerprints, the system probes the discovered networks to discover all the network interface cards that exist on each discovered network and the attributes of each.

Step 204 represents the process of determining what kind of machine is present at each live IP address using different fingerprints, collection instructions or scripts and different communication protocols such as SNMP, FTP, NMAP, SMTP, etc. For each network interface card found, one or more fingerprints for the operating systems the automated attribute data collection process is capable of detecting are used to determine the operating system that is controlling each network asset coupled to one of the found networks by one of the found network interface cards. An entry for each found operating system is then made in the element and data tables that record the type of operating system and its attributes. This process entails running various attribute collection scripts and using various communication protocols and operating system fingerprints and monitoring any responses from the device to determine which fingerprint and script elicited a meaningful response (one that indicates the presence of attributes identified in a fingerprint as present if an OS is a particular kind of OS). A meaningful response to a particular script and fingerprint means the operating system type and manufacturer has been identified for the network asset at that IP address.

Step 206 represents comparing the responses received to the OS fingerprints to determine the type of OS present on each network asset found at a live IP address. One way of doing this is to examine the responses to the different types of communication protocols. For example if one gets a first type response to an SMTP protocol inquiry and a second type of response to an FTP query, a third type of response to an SNMP query and fourth type of response to an NMAP query, then a conclusion can be drawn, for example, that the device is a Cisco router. It may only be possible to determine what type of operating system is present, but in some cases, the type of device also may be determined.

Step 208 represents the process of determining if there is any conflict as to what a machine is based upon the responses it provides and resolving the conflict based upon a weighting scheme. Sometimes it happens that a network asset will give a response to an SNMP (or other protocol) inquiry which will lead to one conclusion about what type of machine it is and will give a response to an NMAP or SMTP inquiry (or other protocol) which will lead to a different conclusion as to what kind of a machine it is. In such a case, the conflict is resolved by using a weighting procedure. For example, there may be a rule that a response to an SNMP inquiry is deemed more trustworthy than a response to an NMAP inquiry or some other similar type rule. In such a case, the weighting procedure weights the conclusion drawn from each response to an inquiry using a particular protocol and then draws a conclusion as to what type of machine gave the responses based upon these weighted conclusions.

If there is a conflict between the conclusions suggested by the responses, the weighting procedure can resolve it automatically.

Step 210 represents doing a level two scan. In a level two scan, a user name and password for each machine about which more information is desired is established. The user name and password can be newly established or pre-existing ones can be assigned for use by the automatic attribute data collection system. The automatic data collection system then uses these user names and passwords to log onto each machine and extract attribute data. This is done using collection instructions for each different type of attribute which cause the automatic data collection system to log onto a machine using the proper protocol, user name and password and give one or more commands that invoke function calls of application programmatic interfaces provided by the operating system. Invocation of these function calls cause the operating system to return various attributes about the machine such as how many CPUs it has, the operating system version, how many hard disks it has, their size and manufacturer, the amount of memory it has, which application programs are present on the machine, etc. The list of attributes which may be elicited is large and it is information about these attributes which can be used to create a unique identity for every machine in the signature process described below.

This process of invoking the function calls of the OS APIs of each machine to extract attribute data is represented by step 212. If a machine type (element) has not yet been recognized, all the scripts from all the fingerprints can be executed to see to which function calls the machine responds. By which function calls to which the machine responds, the type of machine can be determined. In other words, when a particular fingerprint works, the machine is of the type for which the fingerprint was written.

If a fingerprint for a particular type of network asset did not exist in the system before it was installed on the customer's network, and the customer has one of those types of assets on his network, the system will find the network asset, but it will be unrecognized. It will be found because it will respond to a ping with its network interface card. And its operating system will probably be recognized since there are not that many operating systems and fingerprints for most if not all of them exist. However, new machines are being developed every day, and if one of them gets installed on the network, it will not be recognized. Step 214 recognizes this possibility and, when a machine is known to be on a customer's network but its type is uncertain, step 214 puts the machine on a list of unrecognized machine types for the operator to peruse. Step 216 represents the optional process of manually mining the collected attribute data on an unrecognized machine and trying to recognize what type of machine it is. The operator may create a new fingerprint for the machine from the attribute data so collected, and that new fingerprint can then be stored for future use in the automated attribute data collection system to recognize other instances of the same type machine or recognize the particular machine at issue again on a subsequent scan.

Step 218 represents the process of generating a unique ID (signature) for each machine on the network. Typically, this is done by doing a level 2 scan of each machine known to be on the network and collecting a large number of attributes about it. Then a unique ID is generated for that machine by doing an intelligent concatenation of the attributes discovered so as to provide a unique ID that will not match any other ID in the customer's networks. This unique ID is such as to be tolerant to changes such as operating system upgrades, hard disk or motherboard replacements, etc. A summarization of one process to generate this unique ID is found below under the heading SUMMARY OF UNIQUE ID GENERATION PROCESS. More details about the process are found in the section below under the heading DETAILS OF AUTOMATIC GENERATION OF UNIQUE ID FOR EVERY NETWORK ASSET. Anyway of generating a unique ID will suffice, but the preferred process generates this unique ID for each asset in such a way that it is tolerant of change. In other words, the unique ID is flexible enough that the machine will still be recognized when the operating system has been upgraded or the hard disk or motherboard has been replaced.

The automatically discovered attribute data about each element are organized into an automatically discovered asset record which is then stored in the reconciliation database.

Step 220 represents the process of importing asset records from the legacy computer systems of the entity such as the financial asset recording system. This is typically done by running a script that logs onto the fixed asset application programmatic interface and makes function calls to extract the fixed asset records. The assets carried on the financial records computer system or other legacy computer system of the entity may also be extracted by any other method such as the system administrator exporting the fixed asset records of the legacy computer system into a file and importing that file into the system of the invention. In the preferred embodiment, mapping of the imported asset records into a uniform asset record data structure is used to improve the quality and speed of matching. By mapping each field of the imported record into a field in a uniform data structure asset record of the same semantic meaning, confusion of the matching process can be eliminated and complexity of the matching process can be reduced by eliminating the need for program code which can deal with a variety of different names for the same thing.

The next step of the process is represented by block 222. This step is the first phase matching process which uses exact matching rules to do reconciliation between the automatically discovered asset records and the legacy asset records derived from the asset records imported from the legacy system. This reconciliation can also be done manually in some embodiments or by a combination of both manual reconciliation and some reconciliation done by automatic matching rules in other embodiments. Typically, the reconciliation is done first using automatic matching rules. Then, whatever assets that are left over after that process is accomplished can be manually examined and the list of automatically discovered assets and their attributes compared to a list of unmatched legacy asset records.

The automatic asset matching rules are manually written in advance in some embodiments to match assets which have the same attributes or a subset of one or more attributes which matches. The rules can be anything that work to make matches based upon attributes between assets discovered on the network by the automatic asset discovery process and assets imported from the financial reporting system.

The automatic matching rules may not be able to reconcile all assets. In such a case, the attributes of assets discovered on the network can be displayed and compared to attributes of legacy asset records. Whenever a match is made manually, another rule is made that links the two asset records (the asset found on the network by the automatic discovery process to the legacy asset record) together for all time so that on subsequent scans, if these two asset records are found again, they will be reconciled as the same asset.

The process of creating these linkages is represented by step 224. Typically this is done by making a table entry for each match relating the asset's description in the financial reporting system to the same asset's description and attributes in the list of inventory assets discovered by the automated discovery process.

The manual reconciliation process part of phase one can be eliminated in some embodiments since the manual search phase 333 and the manual data entry process 337 in FIG. 4 both can be used to do this function. Manual reconciliation can be done using data from purchase requisition and purchase order tracking computer systems including purchase requisitions, purchase orders, receipts and invoices, as well as fixed asset records on a legacy financial reporting system and/or asset records in a legacy Information Technology asset tracking system as well as the attribute data automatically collected using the discovery process.

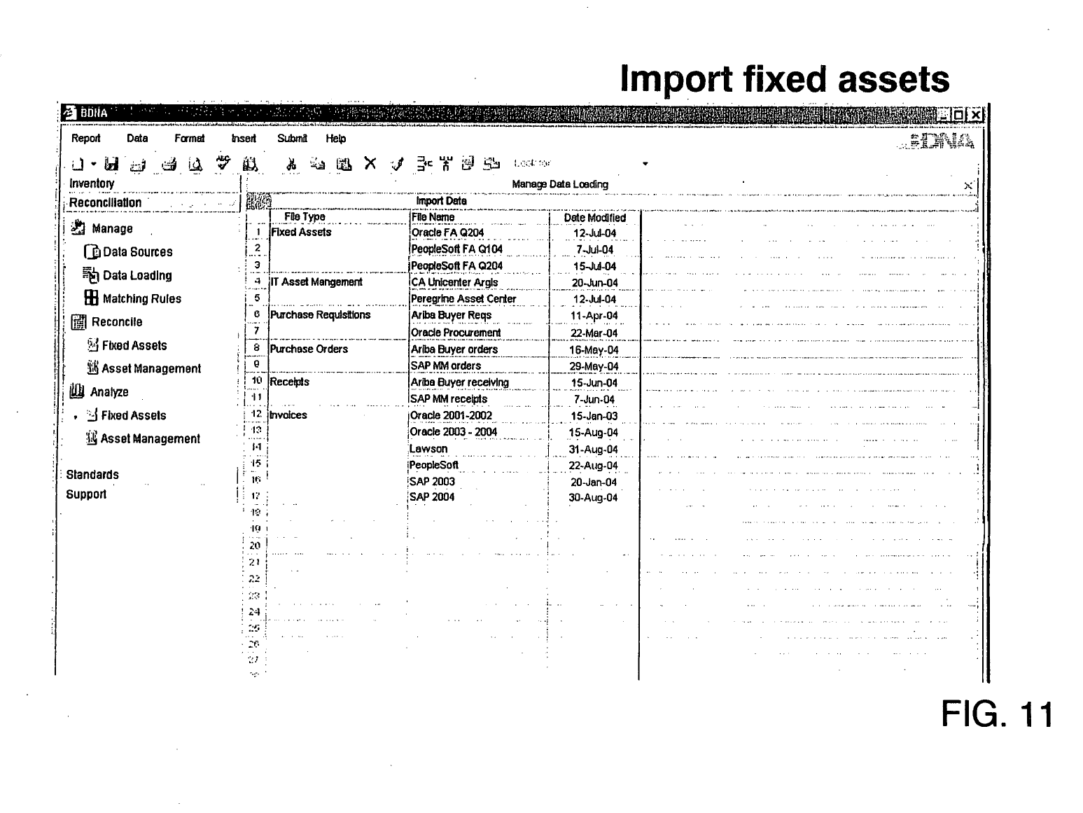

FIG. 11 is a screen shot of a typical starting point in the first phase rules based matching process. This screen shot shows the situation after the assets on the client's networks have been automatically discovered (the so called “inventory” assets which give rise to the automated discovery asset records in the reconciliation database) and some fixed assets have been entered into the system manually. It also shows some lagacy asset records which have been created from asset records imported from the IT asset management system, from purchase recquisitions, purchase orders, receipts and invoices.

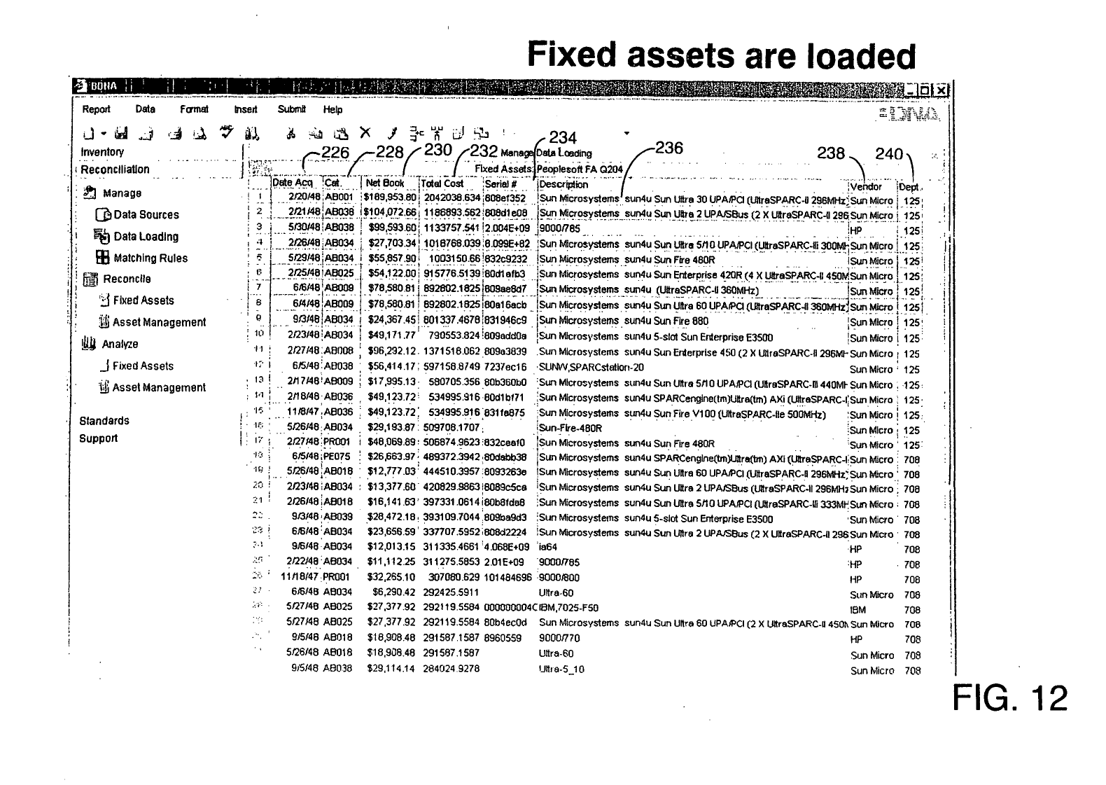

FIG. 12 is a screen shot of a typical list of legacy asset records derived from asset records stored in a legacy computer system such as the financial systems of a corporation into the asset reconciliation and linkage system. The fixed assets shown in FIG. 11 are only a small percentage of the fixed assets the corporation owns. Icon 400 is invoked by a user to cause importing of asset records from a legacy system, and post processing to map the data of these records into a uniform asset record data structure. After importing the rest of the fixed assets from the legacy systems of the corporation, the fixed asset list looks like that shown in FIG. 12. Typical data that is imported from the legacy systems of the corporation are the date of acquisition (column 226), the catalog number or asset number assigned by the legacy system of the corporation (column 228), the net book value (column 230), the total cost of the asset (column 232), the serial number of the asset (column 234), the text description of the asset carried in the legacy system asset record (column 236), the vendor of the asset (column 238), and the department in which the asset is located (column 240). Some minor description of attributes of the asset such as clock speed may also be included in column 236.

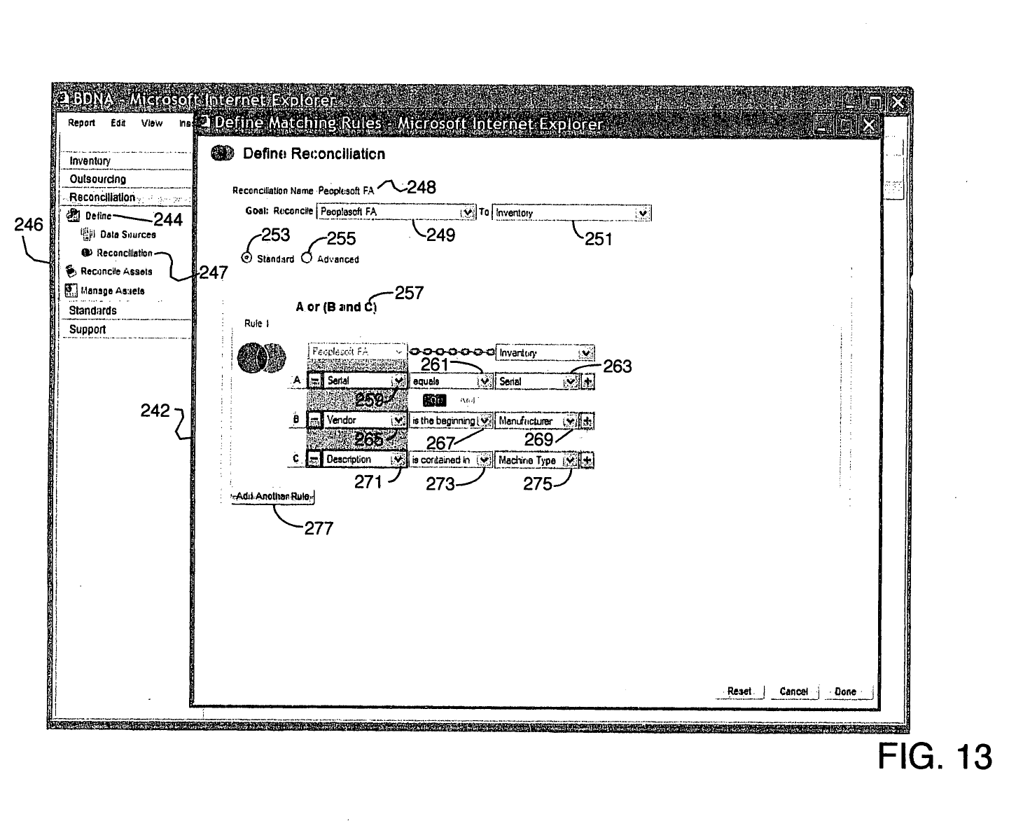

FIG. 13 is a screen shot of a rule definition screen in a first phase of the multiphase matching process. The rule definition screen provides a user interface tool which allows definition by an operator of automatic matching rules. These automatic matching rules are then used to match fixed assets\records derived from asset records imported from the legacy computer systems to inventory asset records. Dialog box 242 is used to define a new matching rule. This dialog appears when the Reconciliation icon 247 under the Define icon 244 is selected in the navigation pane 246. String 248 contains text string “Peoplesoft FA” which indicates the name of the set of exact matching rules the operator wishes to define. Box 249 contains the name of the asset record set for a first set of asset records to be used in the matching process. The down arrow at the end of this box means the user can launch a drop down menu which provides a list of names of the various asset record sets stored in the reconciliation database as the first set of asset records against which to apply the matching rules. The string Peoplesoft FA indicates the name of the specified group of asset records is Peoplesoft FA, and this generally means this group of fixed asset records was imported from a legacy computer system named Peoplesoft FA. The box 251 contains a string which is the name of a second set of asset records against which the exact matching rules are to be applied. The down arrow at the end of this box means the user can launch a drop down menu which provides a list of names of the various asset record sets stored in the reconciliation database as the second set of asset records against which to apply the matching rules. In this example, the string “Inventory” means the second set of records to be used in the matching process are the inventory asset records stored in the reconciliation database. These are asset records which have either been created from assets automatically discovered on the network(s) of the client or which have been imported from a legacy computer system of the client.

Radio buttons 253 and 255 indicate there is a choice between standard and advanced templates to define exact matching rules. The standard template is shown. It has three subpart rules which the user can define designated A, B and C. Boolean expression 257 is a Boolean expression which the user can program which defines how the results of subpart rules A, B and C are to be combined to determine if the rule has detected an exact match. In this particular example, the user has defined that an exact match will result if either subpart rule A finds a match or both subpart rules B and C find matches. Box 259 is a drop down menu which allows a user to specify any one of the fields in the asset records from the set of asset records specified by the name in box 249 as the first search term. Box 261 is a drop down menu which allows the user to choose one of a plurality of matching operators such as: equals, “is the beginning of”; “is contained in”; etc. Box 263 is a drop down menu which allows the user to specify any one of the fields of the asset records in the set of asset records identified by the name specified in box 251. Thus, subpart rule A coupled with the Boolean expression 257 means that if the serial number of an asset record in the set of asset records identified by the name in box 249 exactly equals the serial number in an asset record in the set of records identified by the name in box 251, then an exact match is found between these two asset records and they can be sent to the linking process.

Boxes 265 and 271 work the same way as box 259 for subpart rules B and C to specify fields in the Peoplesoft FA asset records. Boxes 267 and 273 work the same way as boxes 261 to specify an operator by which to compare the two fields specified in each corresponding subpart rule B and C. Boxes 269 and 275 work the same way as box 263 to specify fields in asset records of the set identified in box 251 as the second set of criteria to use in the matching processes of subpart rules B and C. The selections made for subpart rule B mean that the content of the vendor field of an asset record in the Peoplesoft FA asset record set is the beginning of the content of the Manufacturer field of an asset record in the inventory asset record set, then there is a match triggered by subpart rule B. Likewise, for rule C, if the content of the Description field of an asset record in the Peoplesoft FA set of asset records is contained anywhere in the Machine Type field of an asset record in the Inventory set of asset records, then subpart rule C has triggered a match. If both subpart rules B and C trigger matches, then a match between the asset records so found in the two asset record sets exists, and this particular rule has found a match between two asset records in different asset record sets, and those two asset records can be sent to the matching process for linking.

Box 277 is a command that can be given which allows the user to open a new dialog box like 242 and define another rule comprised of three subparts. Not all subparts need be used in every rule.

In an alternative embodiment, matching rules can be generated automatically by inference from the mapping of imported records from legacy systems into legacy asset records. The matching rules can be inferred from information gathered during the mapping process. For example, suppose the legacy asset records pertaining to servers are created by mapping data from the manufacturer field of financial system asset records and the vendor field in IT system asset records into a manufacturer field of a uniform data structure legacy asset record. Suppose also that the data so mapped indicated a large number of Sun and IBM servers had asset records in the legacy systems. From this information, an automatic matching rule can be inferred to match an inventory asset record pertaining to a Sun server to look for legacy asset records with the manufacturer field equal to Sun and a serial number which matches the serial number in the inventory asset record. Basically, the more such matching rules which can be generated manally or by inference, and the better the quality of the matching rules, the more matching will occur and the fewer exceptions will result.

Once the phase one automatic reconciliation rules are defined, the rules are applied to the collection of data regarding the legacy asset records hereafter referred to as fixed assets and the automatically discovered asset records hereafter referred to as inventory assets, each with all their attribute data. The automatic matching rules may not look any further than serial numbers or asset numbers.

Any way that the matching rules are applied will suffice. The fastest way is to select one inventory asset record and then apply all the matching rules simultaneously and apply them to every legacy record imported from a legacy system. The only thing that is necessary is for every matching rule to be applied to every legacy record to try to find a match for the inventory asset record and then to move onto the next inventory asset record and repeat the process. Of course, the reverse process could also be performed: selecting a legacy asset record and then applying all the matching rules to every inventory asset record to try to find a match and then moving to the next legacy asset record.

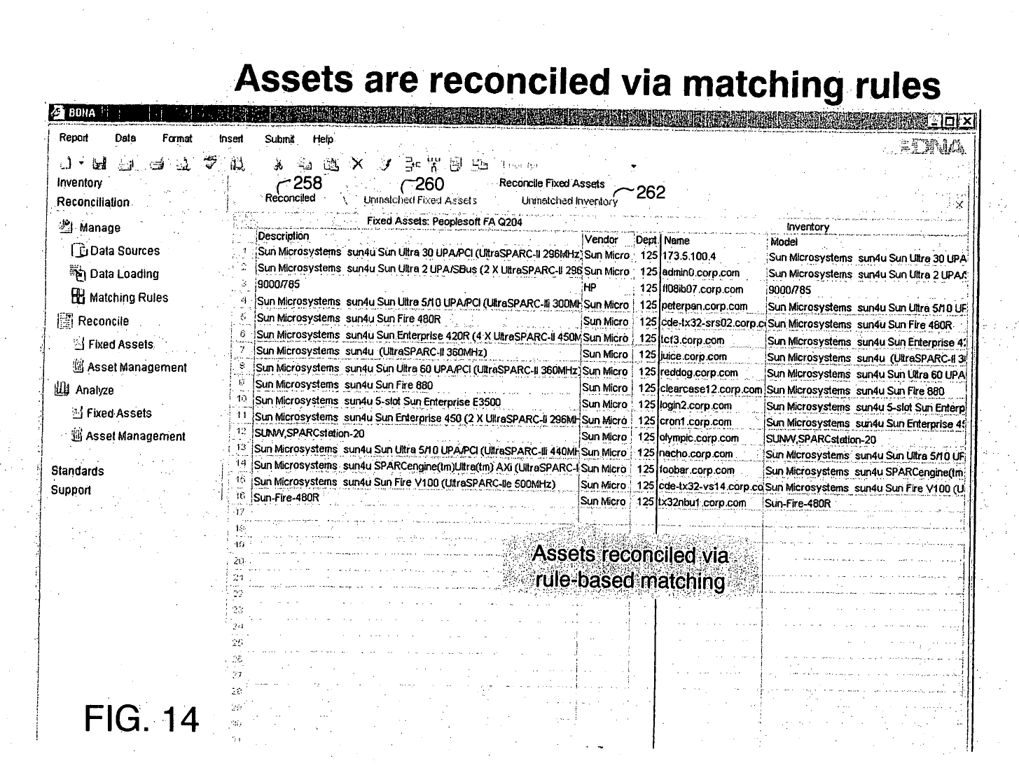

FIG. 14 is a screen shot showing the results of application of the automatic matching rules to the fixed assets imported from the legacy system(s) and the assets found in inventory on the networks. FIG. 14 shows a screen with three tabs 258, 260 and 262 across the top. The first tab “Reconciled” 258 is selected which causes a computer programmed to operate in accordance with the invention to display the list of fixed asset records which have been matched using the automatic matching rules with inventory asset records. The fixed asset records are shown in the column entitled Fixed Assets. The matching inventory asset records are shown in the column entitled Inventory and on the same line as the fixed asset record they each match.

For each match, a linking data entry is made in some kind of data structure such as a table which links the fixed asset record to the matching inventory asset record in the reconciliation database.

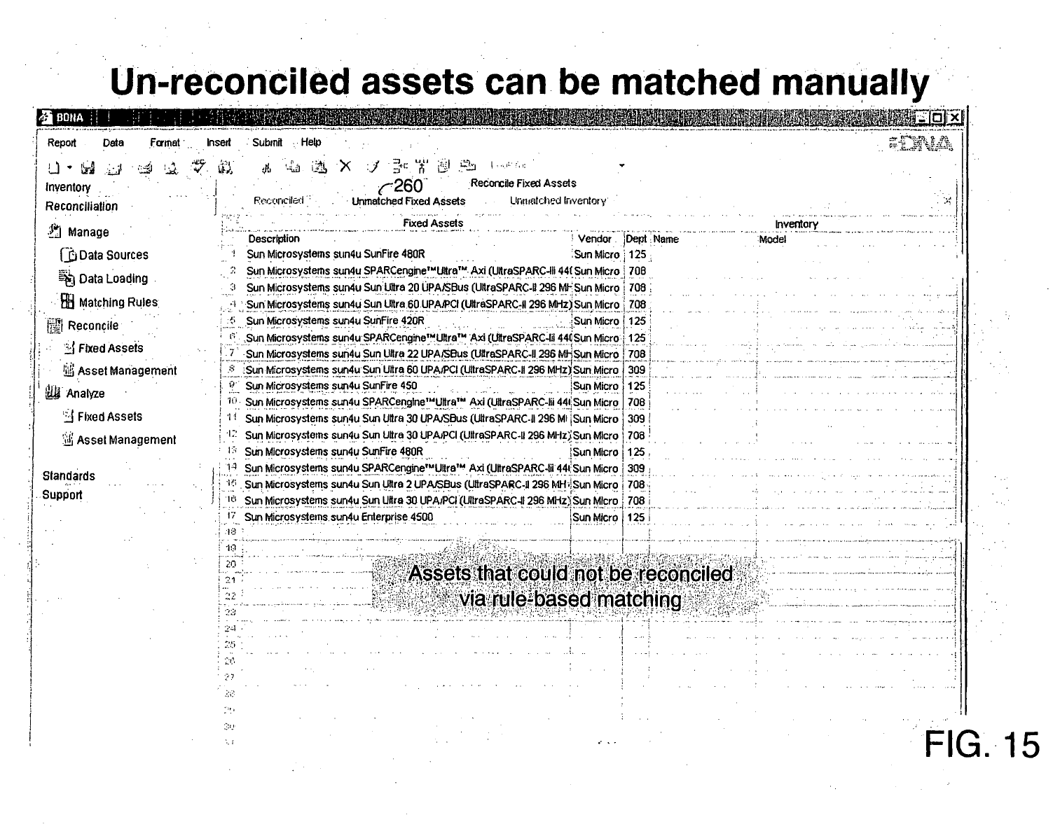

FIG. 15 is a screen shot of a screen of unmatched fixed assets imported from the legacy systems for which the automatic matching rules did not find a match among the assets in inventory discovered in the network by the automatic discovery process. This screen is displayed when the “Unmatched Fixed Assets” tab 260 is selected. These assets carried on the financial reporting system will have to be matched manually if a manual matching process is part of the phase one matching or by one of the matching processes in one of the other phases.

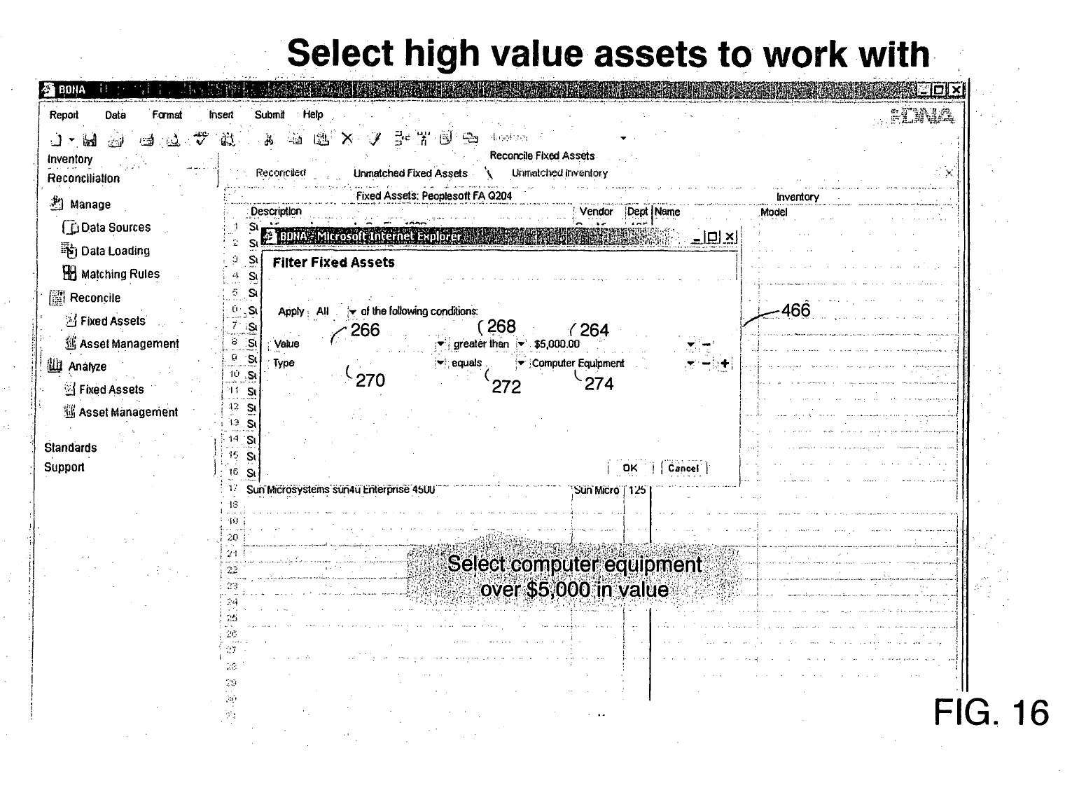

FIG. 16 is a screen shot of a screen wherein filter conditions are set to limit the number of unmatched fixed assets which will be examined manually in the first phase matching process to attempt to find a match in the inventory asset records. Sometimes it is not practical to find a match for every unmatched fixed asset, so it is desirable to establish filter conditions to select only the high value assets to do further investigation to find matches. Financial reporting is not required to be exact, but there is a need for some degree of accuracy at least to comply with the law. The dialog box shown at 264 is used to establish the filter condition. In this particular case, the filter condition is established by setting a value (field 266) to be “greater than” (field 268) $5000 (field 264) and the type of asset (field 270) must equal (field 272) computer equipment (field 274).

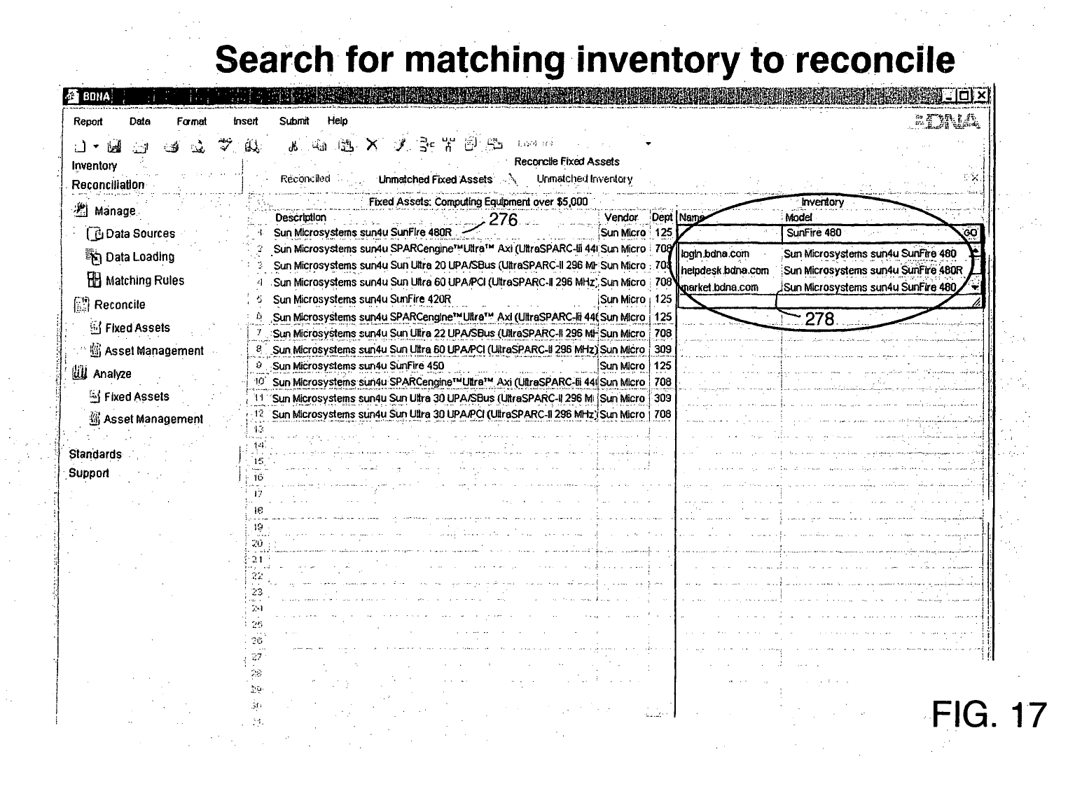

FIG. 17 is a screen shot of one embodiment of a user interface used in the manual search phase of the multiphase matching process showing fixed assets meeting the filter condition set in the screen of FIG. 16 and showing the unmatched automatically discovered asset records for assets in inventory from which a match may or may not be found. In this particular case, there are several Sunfire 480 servers in the inventory asset records which may be selected as the actual inventory asset which corresponds to the legacy asset record for the Sunfire 480 server shown at line 276 on the left side of the display. It is not necessary to get the exact match for purposes of auditing the corporation, so any of the Sunfire 480 servers of the three shown circled on the right side of the display can be selected as matching the legacy asset record at 276 for the Sunfire server.

Suppose the server at 278 is chosen as the matching server from inventory that matches the server shown at 276. Once one of the Sunfire 480 servers on the right side of the display is selected as matching the Sunfire 480 server shown at line 276, linkage data is written which forever records the matching relationship between these two records in the reconciliation database. Therefore, a linking data structure will be created between the legacy asset record at 276 for the Sunfire server from the legacy computer system and the Sunfire server shown at 278 in the group of inventory asset records circled on the right side of the display. This linkage can take any form such as a table which lists the unique ID or signature for the legacy asset record shown at line 276 in one column and on one line of the table and the unique ID or signature for the server in inventory shown at 278 in a different column on the same line of the table. Likewise, the linking data can take the form of a pointer to the record in the inventory data for the Sunfire server shown at 278 this pointer being appended to the legacy asset record shown at 276.

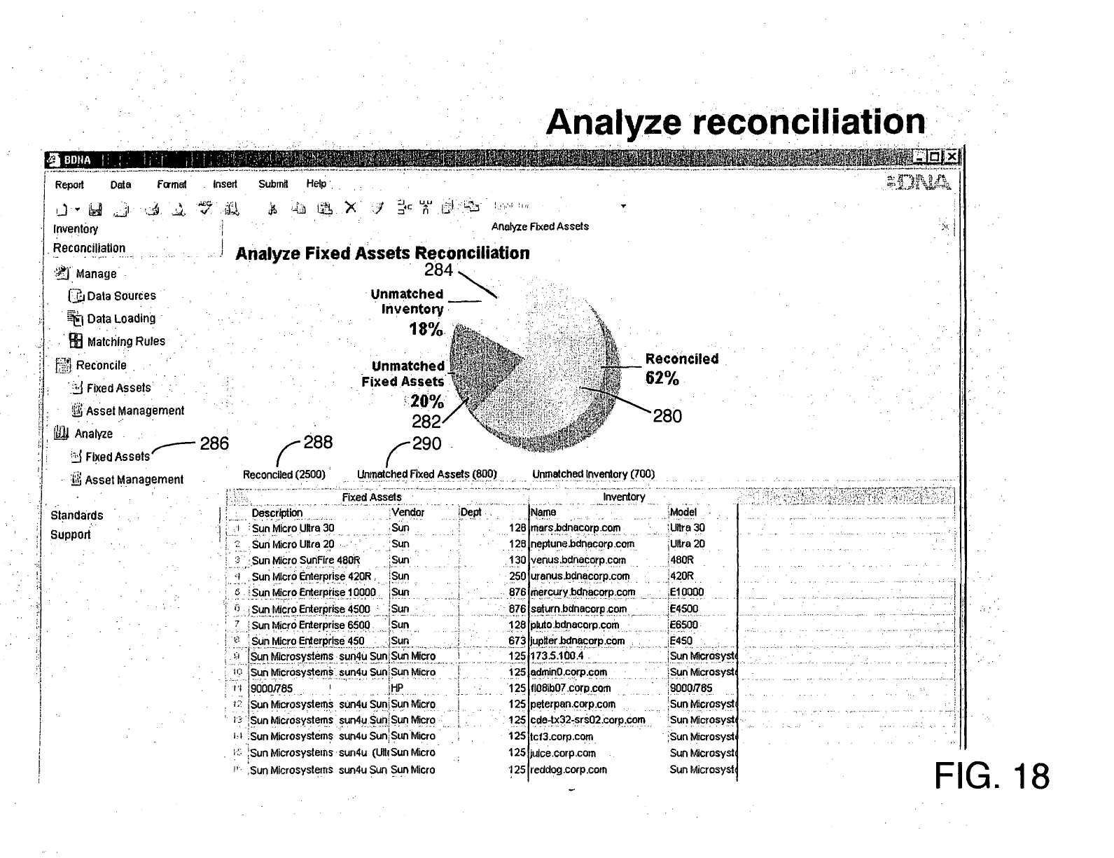

FIG. 18 is a report screen shot showing the results of applying the matching rules and doing the manual reconciliation process of the first phase of matching. This report shows the percentage of reconciled assets (280), the number of unmatched fixed assets (282), and the number of unmatched inventory assets (284). The table shown at the bottom of the screen lists the legacy asset records on the left and the matching inventory asset record on the right side of the screen. This display is generated with the Fixed Assets icon at 286 is selected and the reconciled tab at 288 is selected.

The unmatched legacy asset records which are displayed when the Unmatched Fixed Assets tab 290 is selected and the unmatched inventory asset records which are displayed when the Unmatched Inventory tab at 292 is selected are the exceptions that are reported to the next phase of the multiphase matching process.

Second Phase Details

These exceptions from the first phase are then input as the input data to the second phase of the matching process. The second phase can be any other matching process other than the same rules based matching process used in the first phase. Preferably a fuzzy matching process is used in the second phase to mate records that almost match but which are not exact enough to trigger a rules based match. Manual confirmation on the proposed matches is used in the preferred embodiment. Any resulting matches have the records of the match linked by a pointer or other linking data structure. Again exceptions result.

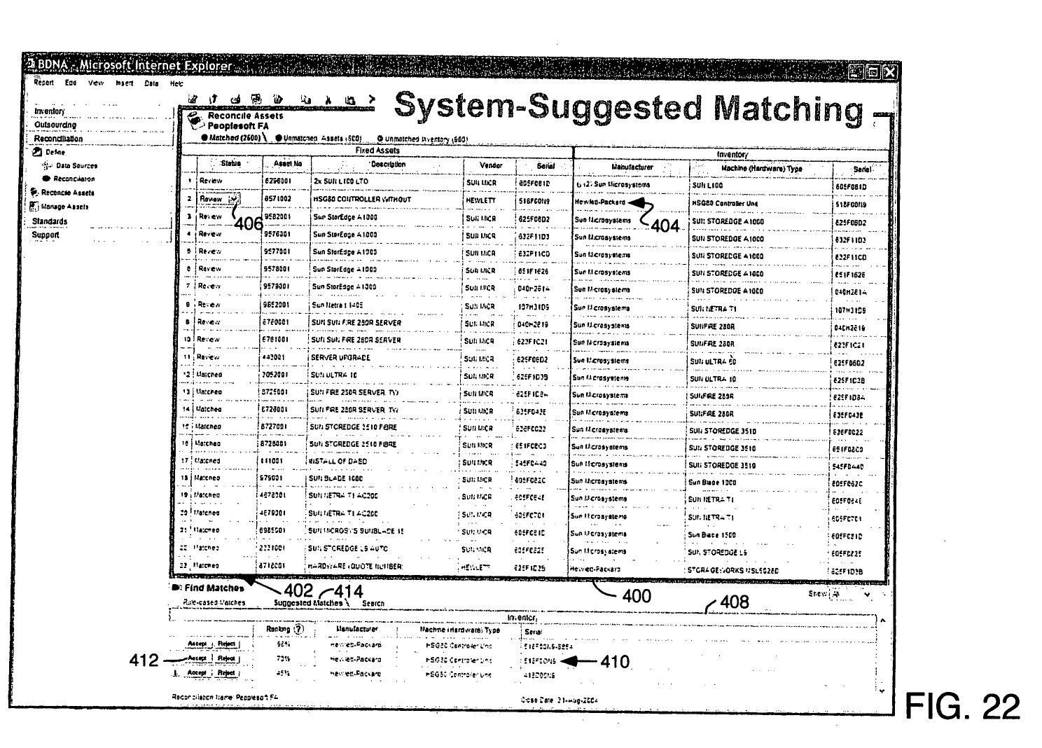

FIG. 22 is a screen shot of a system suggested matching page display resulting from application of fuzzy matching rules. The upper box 400 displays already matched legacy asset records (hereafer referred to as fixed asset records) and inventory asset records (automatically discovered asset records) and matches which are in review status waiting for manual confirmation or rejection. An example of a match is shown at line 12. There, a fixed asset described as a Sun Ultra 10 has been matched to an inventory asset record having the same serial number. In some embodiments, when a fixed asset record has the same serial number as an inventory asset record, the system will automatically declare a match and not wait for manual confirmation. All the matches that are in matched status have the word “matched” in column 402.

An example of a tentative match in review status is shown at line 2. This is a match which resulted from a rules based matching process, but the user has not yet reviewed and accepted the match, and, it is therefore in a review status. All the tentative matches that require manual confirmation have the word “Review” in column 402. The pair of asset records on line 2 comprise a fixed asset record in the left pane and an inventory asset record in the right pane. The fixed asset record on line 2 has been selected for further matching efforts using the fuzzy matching rules of the second phase. The inventory asset record shown at 404 is an exact match generated by the exact matching rules of phase one.

In one embodiment, the fuzzy matching rules preferably start working on finding suggested matches for the fixed asset record on line 2 among the inventory asset records as soon as the fixed asset record on line 2 is selected. In another embodiment, the fuzzy matching rules can be applied at some earlier time to all records, and the contents of box 408 are used to display the results thereof. The purpose of box 408 and the suggested matches tab 414 is to display suggested matches offered by the application of the fuzzy matching rules. The fuzzy matching rules suggest three inventory asset records in box 408 as possible matches for the fixed asset record at line 2. These suggested matches are displayed when the “suggested matches” tab 414 is selected. The proposed match at 410 is not an exact match because the serial number and description do not exactly match their counterparts in the fixed asset record on line 2. The reason that the serial number is not an exact match is because a digit which was supposed to be typed as a zero was typed as an O. The user can then select the Accept command user interface tool shown at 412, and this will cause the inventory asset record 410 to be substituted for the inventory asset record 404 and linking of the inventory asset record to the fixed asset record on line 2.

Third Phase Details

The exceptions records from the second phase are input to the third phase or reconciliation. The third phase is search based matching where tools are presented to the operator of the BDNA server allowing searches to be composed based upon any search criteria the operator desires. Searches of records from different sources based upon properly composed search criteria will result in some additional matches being found. The operator can these cause the matching records to be linked. Exceptions are again created.

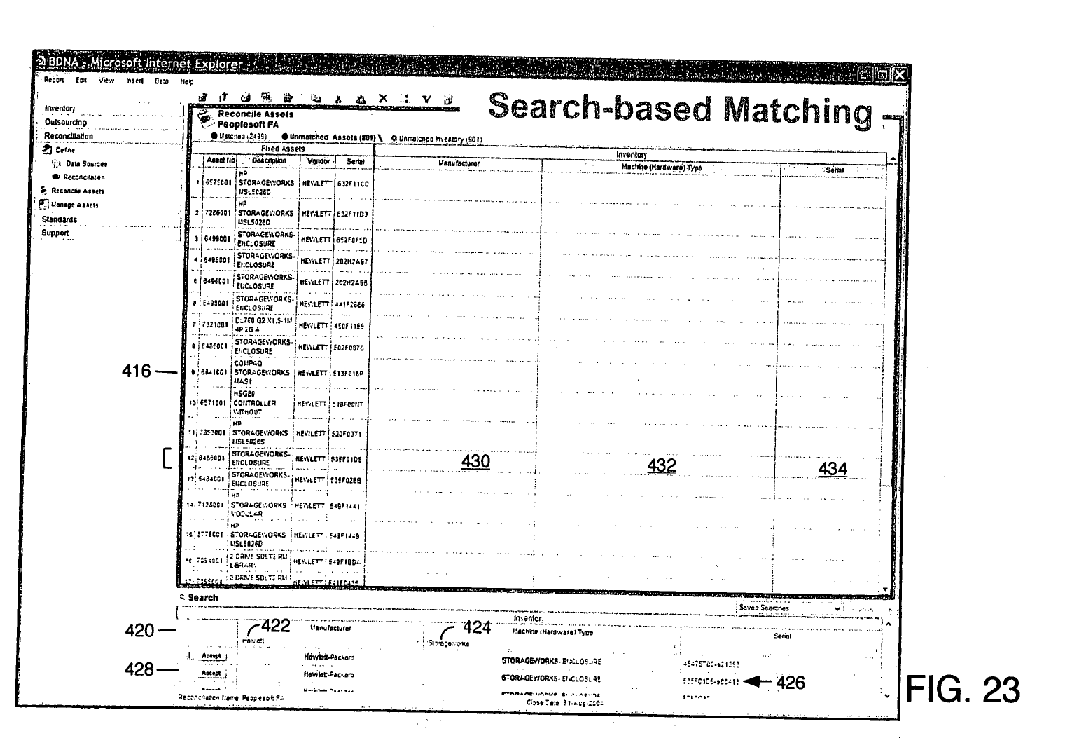

FIG. 23 is a screen shot of the preferred embodiment for a user interface for manual search-based matching displays and tools which can be used to do further matching using manually generated searches. The upper box 416 has three tabs along its top edge: matched; unmatched assets; and unmatched inventory records. The unmatched assets tab 418 is selected, and so the asset records displayed are fixed asset records which have not as yet been matched to an inventory asset record corresponding to the same asset.

Suppose the user wishes to search inventory asset records for a match to the fixed asset record on line 12—a StorageWorks Enclosure purchased from Hewlett. To do this, a manual search can be composed using the user interface tools in box 420. The user surmises that the inventory asset record she is looking for will have Hewlett in the manufacturer field and will have the word StorageWorks in the machine type or description field somewhere. To begin a search, the user types in Hewlett in search box 422 and types in StorageWorks in search term box 424. The search term in search box 422 will be used to find inventory asset records which have this term in the manufacturer field. The search term in search box 424 will be used to find inventory asset records which have the term StorageWorks somewhere in the machine or hardware type description field. This particular search returned several inventory asset records which are shown in box 420, each of which have the search terms highlighted. The inventory asset record shown at 426 has a serial number which is a close but not exact match to the serial number of the fixed asset record on line 12. The user can then select the accept command user interface tool shown at 428 to accept this record as a match. This will cause the inventory asset record shown at 426 to be displayed in the spaces 430, 432 and 434 to the right of the fixed asset record on line 12 and will cause this inventory asset record to be linked to the fixed asset record on line 12 so as to be removed from the processing of the next stage.

Fourth Phase Details

The exceptions from the third phase of reconciliation are input to a fourth phase of reconciliation. The fourth phase is a manual data entry phase which provides tools which allow an operator to manually browse records collected from different sources and look for missing or questionable information such as misspellings, missing serial numbers, obviously wrong entries, etc. These tools allows the user to send queries to the various departments to collect information an and make corrections manually in the records. In one embodiment, the corrected records are then exported back to the original source system through a reverse mapping process. Thus, when these same records are collected again from the source systems on the next iteration of the process, the newly revised records may result in matches in the rules based or fuzzy matching phases so the reconciliation is improved. However, since the manual data entry process creates a new record in the database upon which the matching and fuzzy matching rules work, the new record may be matched with an inventory record on the next iteration of application of the matching rules or fuzzy matching rules.

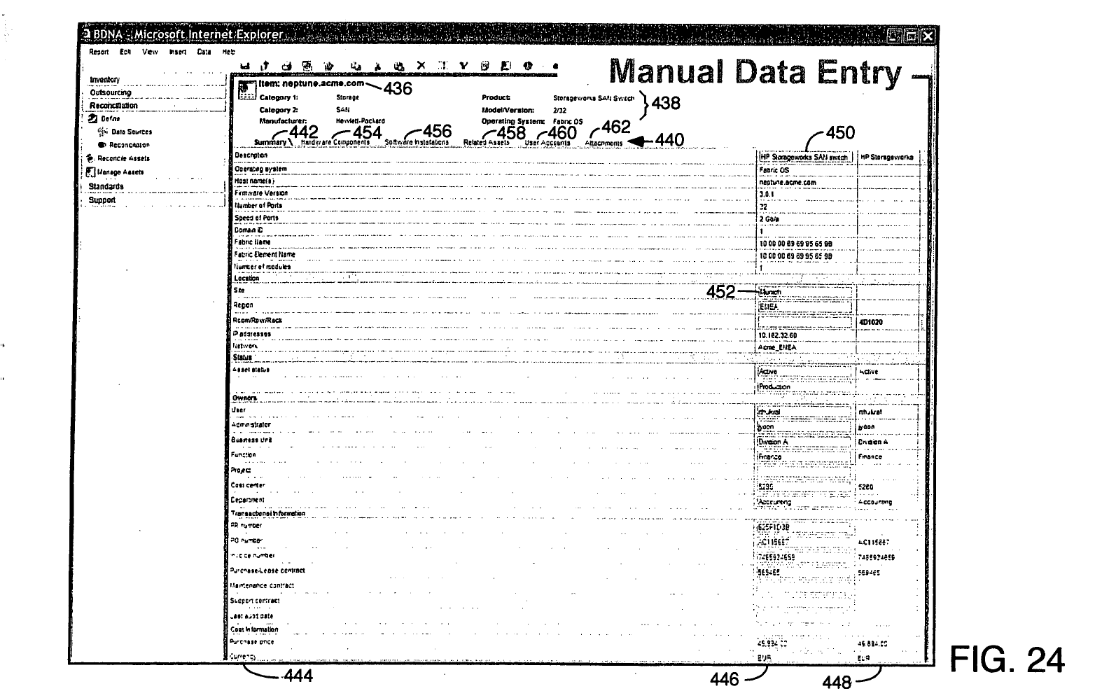

Previously linked records that have already been matched are not collected again in the next iteration of the process. FIG. 24 is a screen shot of the type of user interface display which is presented in the preferred embodiment during the fourth phase. The screen shown is the screen shown when a server having the name neptune.acme.com is selected. The asset record to which the manual data entry screen pertains is shown at 436. There are displayed right below the asset name at 438 a set of six high importance asset attributes which are displayed for quick reference to identity the type of asset. There are six tabs shown at 440 along the top of the page. These tabs are selected to select different pages of information to display about the asset record selected at 436. The summary tab 442 is selected. This causes the fields whose names or semantics are shown in column 444 to be displayed. The values of the data currently stored in those fields are shown in column 446. Column 448 is used to store the original data that was stored in the fields in column 446 which have boxes around them. The data in any field in column 446 which has a box around it is editable such as field 450 and 452. The field next to each of these fields in column 448 stores the original data when the editing starts so the original data can always be recaptured and restored. The systems keeps an audit trail as to who made which changes to which attribute fields and when.

The hardware components tab 454 will, when selected, cause a display of all the disk drives and other hardware components installed on the selected asset. The software installations tab 456, when selected, causes a display of all the software applications that are installed on the selected asset. The related assets tab 458 will cause a display of the related assets such as other assets which are related to the selected assets such as keyboards or monitors that are dedicated to a computer. The user accounts tab 460 shows any user accounts which have been created on an asset such as a server where user accounts are used. The attachments tab 462 will show documents which can be opened which describe something about the selected asset.

There is an annotation capability to annotate the data in fields. The user interface tool to do this is not shown, but it works to generate an electronic “post it” which can be attached to a field of data but which does not change the data stored in that field. The annotation capability is an optional feature on some species. The hard data editing capability is present in the preferred embodiment.

The asset records which are created or edited in the fourth phase can be exported through a reverse mapping process into asset records in any or all of the legacy computer systems. This makes reconciliation easier, but does not solve the problem. Some computer systems do not want asset records exported into them automatically since they need to follow certain procedures in entering asset records. Typically, such systems include the financial reporting system. In such cases, the fourth phase provides tools to generate lists of asset records which have been modified or created. These lists are then used to manually create or edit records in a legacy computer system.

Each time a legacy computer system creates an asset record, it generates an asset ID for the record. This asset ID needs to be reconciled with the unique ID generated by the script driven server for automatically discovered asset records (inventory asset records).

Fifth Phase Details

A final phase provides tools for operators of the BDNA server to make records for newly acquired assets which will be exported through the reverse matching process back to the source systems and be input for the next iteration of reconciliation processing phases.

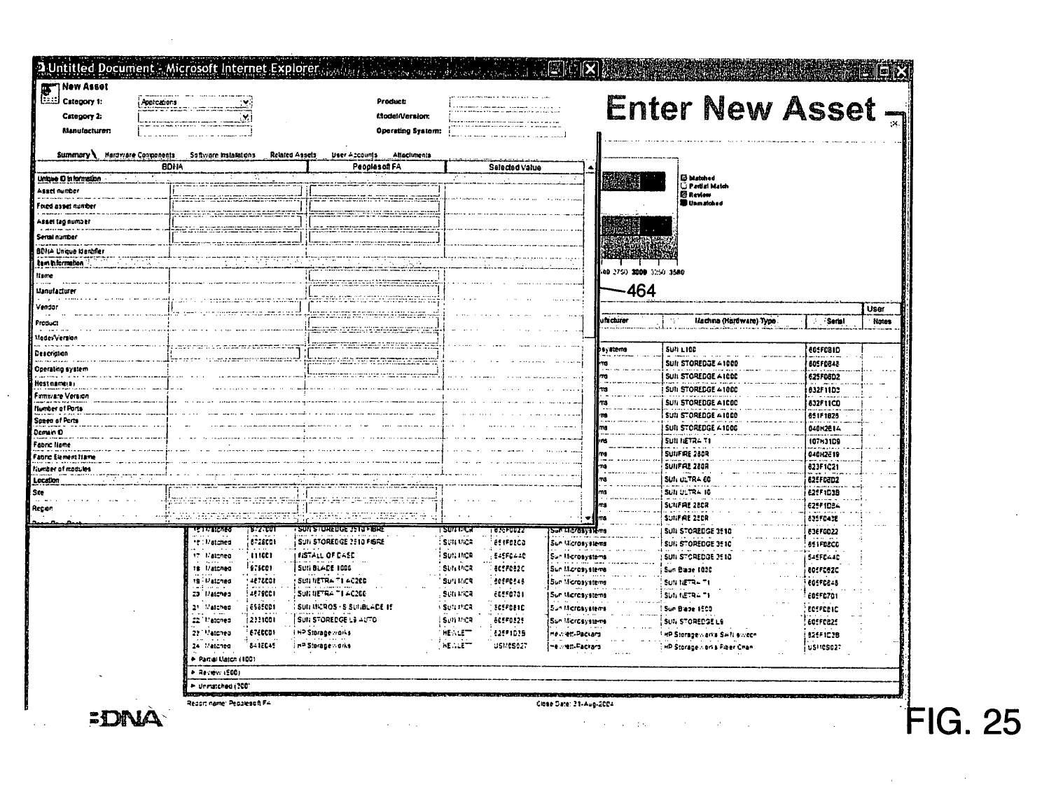

FIG. 25 is a screen shot of a typical user interface used for entering new asset records. The portion of the display below the new asset record box 464 shows already existing asset records. Box 464 is a dialog box like that shown in FIG. 24 but blank and allows new asset record attribute data to be entered in the various fields. In one embodiment, the new asset record can be exported to one or more legacy computer systems or printed out for use manually in creating new asset records in the legacy computer systems. In the preferred embodiment, since the new asset record is created in the database against which the matching rules and fuzzy matching rules are applied, the next iteration of application of those matching rules may result in a match between the new asset record and an inventory asset record.

Summary of Unique Id Generation Process

The unique signature generation system (referred to here as an ID generation system) is involved with and enables methods and/or systems for identifying individual information appliances or devices in an institutional environment using a communication system. In particular embodiments of the unique signature generation subsystem is involved with and enables methods and/or systems for representing and/or managing and/or querying data in an information system that allows a data entity (herein, at times, referred to as a “signature” for an individual system or at other times referred to as a “element” or “inventory asset”) to be developed for a system and further uses that data entity in other management and/or inventory functions.

According to specific embodiments, a data entity used as a signature can be understood as having two important properties: 1) uniqueness (or variance), e.g., the data elements or signatures of two distinct resources cannot generate a match—in other words, there should be sufficient variance between the data that makes up the signatures over all resources that will be analyzed; and 2) persistence or stability, e.g., data elements or signatures extracted from the same information appliance at different times or different circumstances will match, even if the element or inventory asset is upgraded or altered somewhat over time.

In selecting data to use as a signature, it is also desirable that different components of the signature data element have “independence,” where independence means that the components of the data entity (or signature) should contain un-correlated information. In other words, the data entity should not have any internal redundancy. For example, a signature that consists of the hard-drive id and the network card id meets the independence requirement reasonably well, because the two ids are usually not correlated: an upgrade to a hard-drive does not necessarily imply a different network card. However, CPU speed and CPU id, for example, are not independent, because upgrading the CPU will most likely change the CPU id and the speed.

In further embodiments, the unique ID generation system is involved with and enables methods and/or systems for identifying an information system when one or more components are added and/or swapped from that system.

Thus various methods for data representation, data handling, data querying, data creating, and data reporting can be employed in specific embodiments. The unique ID generation system can also be embodied as a computer system and/or program able to provide one or more data handling functions as described herein and/or can optionally be integrated with other components for capturing and/or preparing and/or displaying data such as bar code scanning systems, wireless inventory and/or tracking systems, network management systems, etc.

Various embodiments of the present unique ID generation system provide methods and/or systems that can be implemented on a general purpose or special purpose information handling system using a suitable programming language such as Java, C++, Cobol, C, Pascal, Fortran, PL1, LISP, assembly, SQL, etc., and any suitable data or formatting specifications, such as HTML, XML, dHTML, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

The unique ID generation system and various specific aspects and embodiments will be better understood with reference to the following drawings and detailed descriptions. For purposes of clarity, this discussion refers to devices, methods, and concepts in terms of specific examples. However, the unique ID generation system and aspects thereof may have applications to a variety of types of devices and systems.

Furthermore, it is well known in the art that logic systems and methods such as described herein can include a variety of different components and different functions in a modular fashion. Different embodiments of the unique ID generation system can include different mixtures of elements and functions and may group various functions as parts of various elements. For purposes of clarity, the unique ID generation system is described in terms of systems that include many different innovative components and innovative combinations of innovative components and known components. No inference should be taken to limit the unique ID generation system to combinations containing all of the innovative components listed in any illustrative embodiment in this specification.

Details of Unique Id (Signature) Generation Process

Patent application Ser. No. 10/125,952, filed 18 Apr. 2002 and incorporated herein by reference, discusses systems and methods allowing for the gathering, storing, and managing of various assets in an organization or enterprise. An example inventory system discussed in that application used a communication media, such as an email system and/or computer network, to automatically gather information about assets of an organization and perform various management and inventory functions regarding those assets.

Example systems discussed therein used a data repository structure having elements and attributes, as well as fingerprint modules, collection rules, and other components, to automate much of the data collection of assets within the system.

The present unique ID generation system is related to systems and/or methods that allow a computerized inventory system to identify individual resources (such as computer systems, networks, other information enabled devices, etc.) in a automatic inventory discovery system and keep track of or maintain the identity of those individual items as various characteristics of the assets change over time. In other words unique signatures are generated for the inventory asset records created by the automatic inventory discovery system which generates inventory asset records. The unique ID generation system can be embodied as part of a system such as that described in patent application Ser. No. 10/125,952, filed 18 Apr. 2002 or in other types of computerized inventory systems.

In specific embodiments, the unique ID generation system can be understood as involving deployment of one or more matching rules in a computerized inventory system. Matching rules provide a powerful way to relate characteristics of external resources to data elements and attributes or signatures stored in an inventory information repository. Matching rules can be simple in some embodiments and/or in some situations, but may be complex and nested according to specific embodiments and as various situations and/or applications require.

In alternative embodiments, the unique ID generation system can be understood as involving development of signatures for external resources and storing those signatures in a data store. Signatures, according to specific embodiments of the unique ID generation system, are multiple part and capable of partially matching to external elements and furthermore capable of being updated to represent newly available external data or modified external characteristics.

In order to provide an easier description, the present unique ID generation system will at times herein be described in the context of a system such as one or more of those described in U.S. patent application Ser. No. 10/125,952, filed 18 Apr. 2002. The unique ID generation system is not limited to such systems, however, and can be used in other types of inventory applications. Furthermore, the terminology used in that application should not be used to limit terms as used herein.

For ease of understanding this discussion, the following discussion of terms is provided to further describe terms used herein. These descriptions should not be taken as limiting.

A data element or element for purposes of this description can be understood as a data object within an inventory data repository. In some situations, an element can be generally understood to represent an external asset. One or more attributes having assignable values can be associated with a data element. An element once created or instantiated or added to a data repository system generally persists in the system until it is explicitly removed or possibly joined to another element. An element generally has a unique element_id within the data repository system, and this element_id is independent of any external asset to which the element relates. An element can have various relationships to other elements, for example as parent, child, sibling.

As an example, an individual computer system might have an element structure as follows:

| Attribute Name | Attribute Value |
|---|---|
| Element_Name: | ComputerA |
| IP_ADDR_3: | 30.3.3.3 |
| NIC_MAC_ADDR: | 00:E0:83:24:B7:3C |
| HD_serial_number: | SK434xzh |
| OS_serial_number: | 83084dd3 |

A signature as used for purposes of this description can be understood as a data entity (such as a data element as just described) and/or data method for uniquely and repeatably identifying a particular asset (such as a single computer server system) even after some modification of the asset or change of circumstances. According to specific embodiments of the unique ID generation system, particular types of data elements can be used as signatures. In other embodiments, signatures can be implemented in other ways, such as using hashing functions or combined values, etc.

Attributes and their attribute values are important subparts of data elements. The particular attributes defined for a data element may be determined by a detected nature of that data element, such as the operating system and may change over time as different types of information are collected or become available for a particular external resource.

### OPERATION EXAMPLES

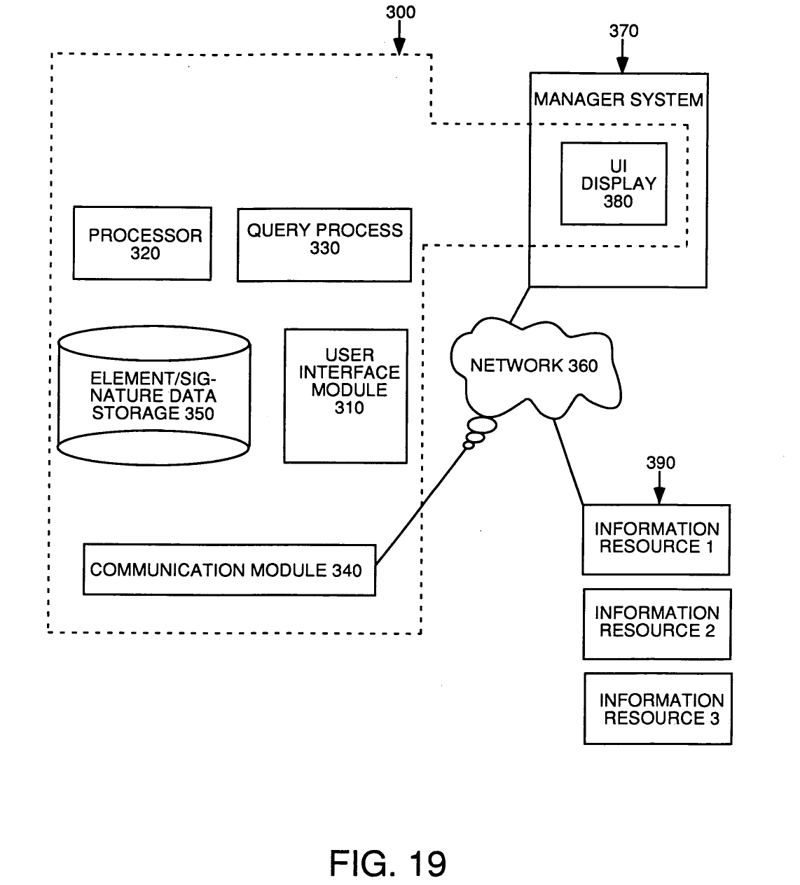

FIG. 19 illustrates a block diagram of a preferred embodiment of the current unique ID generation system in a network environment. According to specific embodiments of the unique ID generation system, the unique ID generation system resides in an information processing logic execution environment, such as system 300, having processor 320, scan/query process 330, a data storage 350, a user interface module 330, communications module 340, and optionally a management console 380. In such an environment, scan/query process 330 is able to scan or probe for possible resources 390 over a network 360. This configuration represents just one possible simple logic execution and network environment, and many others are suitable, as will be understood to those of skill in the art.

According to specific embodiments of the unique ID generation system, the unique ID generation system involves using a network inventory system with one or more matching rules. Matching rules allow a collected data set to be compared against one or more stored data elements in order to be able to detect a particular external resource repetitively and recognize it as the same asset previously discovered and for which an asset record is already stored in a reconciliation database or other data repository.

The following straightforward example illustrates how matching rules according to specific embodiments of the unique ID generation system eliminates double counting of machines.

### Example #1 Comparing Scan Results to Stored Data

In a first example, consider a situation of a local area network for which it is desired to build a data representation of all available devices using an automatic detection and/or inventory system. According to specific embodiments of the unique ID generation system, an inventory system includes a data repository with an interface (for example, a data repository such as described in patent application Ser. No. 10/429,270 filed 2 May 2003), an ability to scan the network to detect responding addresses and make certain queries of devices found at those addresses, and one or more matching rules. In this example, a simple matching rule is that a detected external resource matches a stored element if at least two out of the following three conditions are met:

a. the MAC address of the primary network card detected for the resource is identical to a corresponding attribute value for the stored element;

b. the serial number of the main disk drive detected for the resource is identical to a corresponding attribute value for the stored element;

c. the serial number reported by the operating system of the resource is identical to a corresponding attribute value for the stored element.

In this particular example, this matching rule can be considered to allow for a partial match. In specific embodiments, a system according to the unique ID generation system may keep track of whether a matching rule results in a partial match or a complete match. In other embodiments, a matching rule may just detect and flag a match and not keep track of whether it is partial or complete.

Matching rules according to specific embodiments of the unique ID generation system can be simple or complex and development of various matching rules is within the skill of practitioners in the art. Note that the matching rules used in the unique ID generation system are not the same matching rules as are used in the multiphase matching system. In some embodiments, matching rules can include different weights given to different components, so that a match is always found if two highly weighted attributes match, for example, but is not found if only two lesser weighted attributes match.

In further embodiments, matching rules and associated rules can perform additional processing when it is determined that an attribute of a signature data element has changed. For example, if a network card with a particular address that was previously identified in a particular server is not detected on a future scan, a system according to the unique ID generation system can search current scan records to determine if that network card has been moved to or identified with another server. This can be used by the unique ID generation system as an indication that there could be two servers with nearly the same signature that could be getting confused, or possibly one server that is being counted twice, and would therefore require further investigation. If the network card is seen to disappear on a given asset and is replaced by a new card and does not show up anywhere else in the infrastructure, at some point after one or more scans the unique ID generation system may determine that it has been replaced and delete it from the data representation of the assets.

With a logical matching routine present, an inventory system according to specific embodiments scans or otherwise determines the active addresses in the particular network or domain of interest. Various methods and/or techniques for scanning, for example, all active network addresses are known in the art and may be used according to specific embodiments of the unique ID generation system. In this case, for example, scan results might detect active addresses 10.1.1.1 and 10.1.13.25 and further queries would determine the information as indicated in Table 1.

TABLE 1
SCANRESULTS

| | | |
|---|---|---|
| IPADDRESS | 10.1.1.1 | 10.5.13.25 |
| network card MAC address | 00:E0:81:24:B7:1C | 00:80:AB:29:C3:78 |
| disk driver serial number | SK434xzh | MD40009234 |
| OS serial number | 83084dd3 | f974df56 |

TABLE 2
KNOWNDEVICES

| | |
|---|---|
| IPADDRESS | 10.1.1.1: |
| network card MAC address | 00:E0:81:24:B7:1C |
| disk driver serial number | SK434xzh |
| OS serial number | 83084dd3 |

With this information, an inventory system according to specific embodiments of the unique ID generation system then compares each responding network address with every “known” device (e.g., a known device system in specific embodiments can be defined as every device for which an element is created and stored and retrievable from a data repository, for example as shown in Table 2) and uses the example matching rule provided above. In this case, the comparison might proceed as follows:

(1) Compare IP address value “10.1.1.1” against known devices (in this simple example, one at this point). In this case, using the matching rule above, indicates that 10.1.1.1 matches the existing element and the matching process proceeds to the next scanned device.

(2) Compare 10.5.13.25 against all known device elements using the matching rule. Since there is no match, the unique ID generation system creates a new device data element and set the data element's attribute values to the information learned from the scan (e.g., the MAC address and serial numbers) to those collected from address 10.5.23.25.

(1) Compare IP address value “10.1.1.1” against known devices (in this simple example, one at this point). In this case, using the matching rule above, indicates that 10.1.1.1 matches the existing element and the matching process proceeds to the next scanned device.

### Example #2. Identifying a Device that has Changed Over Time.

In a further example, consider network scan data on a particular date (e.g., January 1 of the year) with the following response:

from IP address 10.1.1.1:
network card MAC address=“00:E0:81:24:B7:1C”
disk driver serial number=“SK434xzh”
OS serial number=“83084dd3”

If there are other device elements stored, the unique ID generation system then examines them using a matching rule such as the example described and if there is no match (for example because this is the first device), the unique ID generation system creates a new device element and sets the device element's attribute values (i.e., the MAC address and serial numbers) to those from 10.1.1.1.

On January 5, the network card of 10.1.1.1 is replaced with a faster network card. The new network card has the MAC address “00:E0:81:24:FF:EE”. On January 10, a network scan using the data repository built from the January 1 proceeds as follows:

(1) if necessary, load device identification method(s) (e.g., fingerprints described in related patent applications)

(2) detect a live IP address at 10.1.1.1

(3) determine that IP address 10.1.1.1 runs HP-UX (for example using a fingerprint system as described in above referenced patent applications)

(4) attempt to collect attribute information from each system, such as network card MAC address, disk drive serial number, and operating system serial number.

For example, from 10.1.1.1:
network card MAC address=“00:E0:81:24:FF:EE” (different from previous scan)
disk driver serial number=“SK434xzh”
OS serial number=“83084dd3”

(5) Examine known device data elements and determine if currently collected data matches an existing device data using the example matching rule described above;

(6) Compare 10.1.1.1 against the data element/signature created from the January 1 scan. With an appropriate matching rule, match on two out of the three attributes (disk drive serial number and OS serial number) and thus conclude that the newly collected data is from the same external device.

(7) Update the stored attributes with the latest values collected from 10.1.1.1. the device's network card MAC address attribute is set to “00:E0:81:24:FF:EE”.

As a further example, on January 15, the hard drive on 10.1.1.1 is replaced or updated, causing a new hard driver serial number “GX152248”. On January 20, another network scan collects attribute data from 10.1.1.1 and a matching rule determines that the element should again be updated.

Using Elements as Signatures

In further embodiments, the unique ID generation system can be understood as a mechanism for using data elements records, with their associated attributes, as signatures to identify particular devices. As with the description above, matching rules as those described can be used to determine with signatures that include some variation in fact match the same device or are related to different devices.

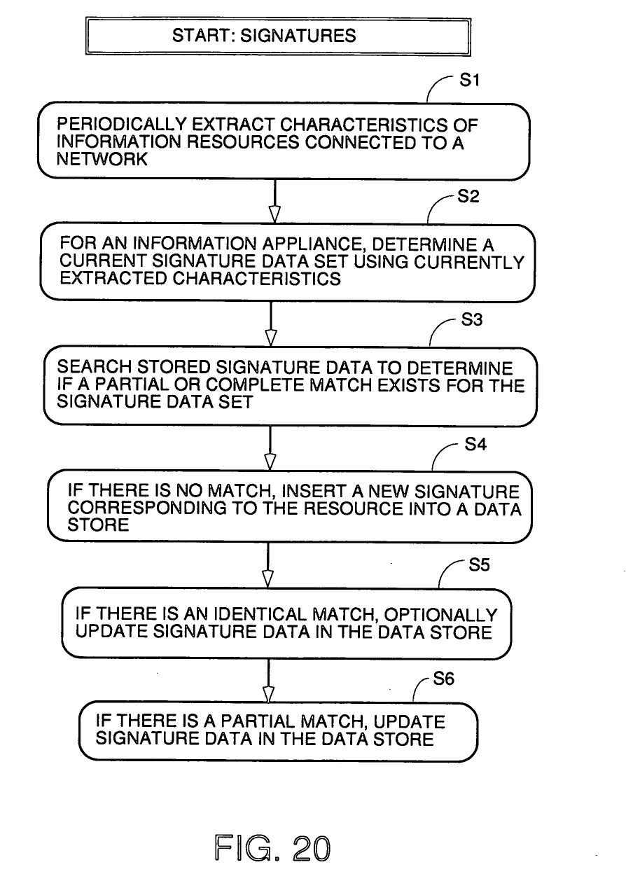

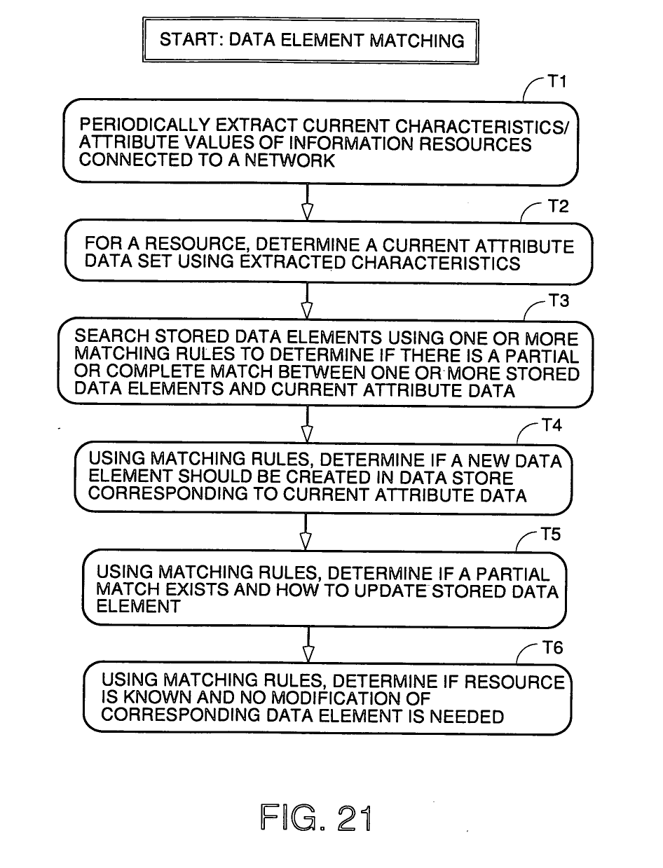

Thus, according to specific embodiments, the present unique ID generation system can also be understood as involving a method that can be executed on a computer system. Methods according to the unique ID generation system can be characterized in terms of data elements and/or signature analysis. Thus, FIG. 20 is a flow chart illustrating steps of creating a signature according to specific embodiments of the unique ID generation system. Alternatively, FIG. 21 is a flow chart illustrating steps of using matching rules to compare data elements according to specific embodiments of the signature generation system using other values as signatures.

As a further example, a number of other values can be used as signature data sets according to specific embodiments of the unique ID generation system. For example, in networked environments, it might be the case that one or more types of network requests typically generates a response packet having particular values. In such cases, the response packets can either be stored as signature data or can be combined or hashed into more standardized values.

In such a case, a signature can be developed and stored as either a group or a sequence of numerical data. For example, a signature might be composed of ten order four-byte numbers, one representing an IP address for a system, one representing a hash value derived from an operating system serial number of a system, one representing a reported hard disk serial number, etc. In this case, as with above, partial matches may be allowed on some subset of the signature data, and the stored signature updated with new data. This type of hashed value signature which can be updated may be used instead of or in conjunction with a multi-part data element as described above in specific embodiments. Thus, as an example, the attribute data shown in the table below can be transformed and stored into a signature data value as follows.

| | | |
|---|---|---|
| IPADDRESS | 10.1.1.1 | SD1: 10.1.1.1 |
| network card MAC address | 00:E0:81:24:B7:1C | SD2: 0.224.129.36 |
| | | SD3: 183.28.0.0 |
| disk driver serial number | SK434xzh | SD4: 198.234.17.65 |
| OS serial number | 83084dd3 | SD5: 139.44.68.15 |

In this example, various data collected from a resource has been converted into five, 32 bit signature date words. This conversion can be by a variety of means, including various conversion and/or hash functions, as will be understood in the art.

Although the invention has been described in terms of the preferred and alternative embodiments described herein, those skilled in the art will appreciate other alternative embodiments which do not depart from the spirit and scope of the claimed invention. All such embodiments are intended to be included within the scope of the claims appended hereto.

What is claimed is:

1. A multistep process for reconciling asset records, comprising:
A) creating inventory asset records in a reconciliation database;
B) creating legacy asset records in said reconciliation database;
C) performing a multiphase matching process to attempt in each phase to reconcile said legacy asset records with said inventory asset records, said reconciliation process being an attempt to determine which legacy asset record(s) pertain to the same physical asset to which an inventory asset record pertains, and wherein each said phase of said multiphase matching process uses a different technique for matching records including at least an exact matching rule phase, a fuzzy matching rule phase and a manually generated search phase, and wherein at the end of each said phase unmatched asset records are reported as exceptions to the next phase in said multiphase matching process; and
D) in each phase of said multiphase matching process where one or more matches is found, for each match found, generating linking date which creates a link between the matching asset records.

2. The process of claim 1 wherein step A comprises importing inventory asset records pertaining to assets on a network of an entity which have been generated from attribute data discovered by an automatic discovery process capable of automatically discovering assets on a network of an entity and discovering attribute data pertaining to each said asset so discovered, and wherein step B comprises importing asset records from legacy computer system of said entity and mapping the fields of each said record into a field having the same semantic definition in a uniform asset record structure in said reconciliation database to generate said legacy asset records in said reconciliation database in addition to said automatic discovery records.

3. The process of claim 1 wherein a first phase of said multiphase matching process involves using exact matching rules defined by a user and containing one or more subparts which are combined according to a Boolean expression defined by a user to compare one or more attributes of each asset record in a first set of asset records in said reconciliation database to one or more attributes of each asset record in a second set of asset records in said reconciliation database, and wherein a match is compared if said one or more subparts create matches in the manner specified by said Boolean expression.

4. The process of claim 3 wherein said multiphase matching process further comprises one or more phases comprising presenting user interface tools which can be invoked to manually create or edit or annotate one or more asset records in said reconciliation database.

5. The process of claim 3 wherein said multiphase matching process further comprises presenting one or more user interface tools which can be invoked to selectively export any new, edited or annotated asset record into an asset record on a legacy computer system via a reverse mapping process or generate a report of new asset records and manully corrected or annotated legacy asset records for use by operators of a legacy computer system to manually create or correct asset records on said legacy computer system.

6. The process of claim 1 further comprising a step of presenting user interface tools which can be invoked by a user to manually define said matching rules before using said matching rules to compare asset records, and further comprises displaying a proposed match generated by an exact matching rule or a fuzzy matching rule to an operator and requesting manual confirmation and not creating said linking data until a confirmation of a match is received.

7. The process of claim 3 wherein step B comprises importing asset records from other computer systems of said entity and mapping the fields of each said record into a field having the same semantic definition in a uniform asset record structure in said reconciliation database to generate said legacy asset records in said reconciliation database in addition to said inventory asset records, and further comprising the step of automatically generating said matching rules from information gained or inferred from processing during said mapping process.

8. The process of claim 1 wherein a second phase of said multiphase matching process comprises using fuzzy matching rules which do not require an exact match to compare said inventory asset records to said legacy asset records in said reconciliation database.

9. The process of claim 1 wherein a first phase of said multiphase matching process involves using exact matching rules to compare legacy asset records in said reconciliation database to said inventory asset records, and wherein a second phase of said multiphase matching process comprises using fuzzy matching rules which do not require an exact match to compare said inventory asset records which were not matched with any legacy asset record in said first phase to said legacy asset records which were not matched with any automatic discovery asset record in said first phase.

10. The process of claim 9 wherein a third phase of said multiphase matching process comprises presenting user interface tools to a user to browse asset records in said reconciliation database which have not had matches found and compose one or more searches based upon search criteria suggested by the records being browsed to find matching records among other asset records in said reconciliation database.

11. The process of claim 1 wherein a third phase of said multiphase matching process comprises presenting user interface tools to a user to browse legacy asset records in said reconciliation database which have not had matches found and compose one or more searches based upon search criteria suggested by the records being browsed to find matching records among said inventory asset records in said reconciliation database.

12. The process of claim 1 wherein a unique identification or signature is created for each legacy asset record and each automatic discovery asset record, each said unique identification or signature being stored in said reconciliation database and used when importing asset records from legacy computer systems or inventory asset records to determine if a record already exists in said reconciliation database corresponding to the asset said imported asset record or said automatic discovery asset record describes so that legacy asset records and inventory asset records which are already in said reconciliation database and which have already been matched are not overwritten by new legacy asset records or newly imported inventory asset records that describe the same asset as the legacy asset records and inventory asset records which have already been matched.

13. The process of claim 1 wherein a fourth phase of said multiphase matching process comprises presenting user interface tools a user can use to browse legacy asset records in said reconciliation database which have been matched to automatic discovery records in said reconciliation database and correct any incorrect entries in fields of said legacy asset records or fill in information missing from fields of said legacy asset records.

14. The process of claim 1 wherein a fourth phase of said multiphase matching process comprises presenting user interface tools a user can use to browse legacy asset records in said reconciliation database which have been matched to automatic discovery records in said reconciliation database and annotate any incorrect or incomplete entries in fields of said legacy asset records so as to suggest needed corrections or the data which should be filled into a field with missing data.

15. The process of claim 1 wherein a fourth phase of said multiphase matching process comprises presenting user interface tools a user can use to browse legacy asset records in said reconciliation database which have been matched to automatic discovery records in said reconciliation database and send a message to an appropriate person or department requesting that information about a particular asset be verified or looked up and returned.

16. The process of claim 1 wherein a fourth phase of said multiphase matching process comprises presenting user interface tools a user can use to browse legacy asset records in said reconciliation database which have been matched to automatic discovery records in said reconciliation database and mark up the data in fields to make corrections or add data to fields which are missing data, and wherein a command can be given to accept changes in an asset record which results in corrected data or additions of missing data being accepted as the new data stored in the fields which have been marked up.

17. The process of claim 1 wherein a fourth phase of said multiphase matching process comprises presenting user interface tools a user can use to browse legacy asset records in said reconciliation database and mark up the data in fields to make corrections or add data to fields which are missing data, and wherein a command can be given to pass the legacy asset record so annotated back to a legacy computer system for manual correction there of an asset record from which said legacy asset record was derived.

18. The process of claim 2 wherein a fourth phase of said multiphase matching process comprises presenting user interface tools a user can use to browse legacy asset records in said reconciliation database and correct, markup or annotate data in fields which is incorrect in order to make corrections or add data to fields which are missing data, and wherein a command can be given to reverse map said corrected or annotated legacy asset record to cause an asset record with fields corrected per said corrections, markups or annotations to be exported back to a legacy system from which it came.

19. The process of claim 1 further comprising the step of presenting user interface tools for searching asset records in said reconciliation database or correcting data or annotating data in asset records in said reconciliation database or communicating with custodians of assets to request information for use in correcting erroneous data in asset records or filling in missing data.

20. The process of claim 17 wherein said user interface tools are presented for invocation by a user during all phases of said multiphase matching process.

21. A multistep process for reconciling asset records, comprising:
A) importing or creating in a reconciliation database inventory asset records of attribute data pertaining to assets on a network of an entity, and generating a unique signature for each said inventory asset record from attribute data of said automatic discovery asset record, and determining if an inventory asset record with the same unique signature already exists in said reconciliation database, and, if so, not overwriting the preexisting inventory asset record with said newly imported or created inventory asset record, and if not, storing said newly imported or created inventory asset record in said reconciliation database;
B) importing from one or more legacy computer systems asset records into a reconciliation database, said asset records pertaining to some or all of the same assets which resulted in generation of said inventory asset records;
C) mapping the data in fields of each said asset record imported from said one or more other legacy computer systems of said entity into corresponding fields having the same semantic meaning of a corresponding new legacy asset record, and generating a unique signature for each said legacy asset record that has passed through said mapping process from attribute data of said legacy asset record and determining if a legacy asset record with the same unique signature already exists in said reconciliation database, and, if so, not overwriting the preexisting legacy asset record with said new legacy asset record, and if not, storing said new legacy asset record in said reconciliation database;
C) performing a multiphase matching process to attempt in each phase to reconcile said legacy asset records with said automatic discovery asset records, said reconciliation process being an attempt to determine which legacy asset record(s) pertain to the same physical asset to which an automatic discovery asset record pertains, and wherein:
a first phase comprises application of exact matching rules to said legacy asset records and said inventory asset records, and displaying for operator confirmation asset records which are a possible match according to said exact matching rules, and receiving operator confirmation of a match, and passing information about which asset records match to a linking step where linking data is added to said matching asset records to link them together in said reconciliation database, and passing along information about which asset records remain unmatched as exceptions to a second phase of said multiphase matching process;
a second phase comprises application of fuzzy matching rules to said exceptions from said first phase in attempts to find further matches, said fuzzy matching rules presenting to an operator a list of proposed matching asset records which have sufficient information in common with another asset record to constitute a possible match, said sufficient information being defined according to one or more fuzzy matching rules, and receiving any operator input selecting a proposed matching asset record as a match-in-fact, and, if such operator input is received, and passing information about which asset records match to a linking step where linking data is added to said matching asset records to link them together in said reconciliation database, and passing along information about which asset records remain unmatched as exceptions to a third phase of said multiphase matching process; and
a third phase comprises presenting user interface search tools to a user to browse a first type of asset records in said reconciliation database which have not had matches found and compose one or more searches based upon search criteria supplied by an operator to find matching records among a second type of asset records in said reconciliation database, and, if an operator recognizes any of the asset records returned by said search as a match for another asset record, receiving user input selecting the asset record returned by said search and passing information about which asset records match to a linking step where linking data is added to said matching asset records to link them together in said reconciliation database, and passing along information about which asset records remain unmatched as exceptions to a fourth phase of said multiphase matching process.

22. The process of claim 21 further comprising implementing a fourth phase of said multiphase matching process comprising presenting user interface correction tools a user can use to browse legacy asset records in said reconciliation database and correct, markup or annotate data in fields which is incorrect in order to make corrections or add data to fields which are missing data,
and further comprising presenting a user interface reverse mapping tool which can be invoked to give a command to reverse map said corrected or annotated legacy asset record to cause an asset record with fields corrected per said corrections, markups or annotations to be exported back to a legacy computer system from which it came,
and further comprising presenting said user interface searching tools and said user interface correction tools during each of said first, second and third matching phases such that said user interface searching tools and correction tools can be invoked to search for asset records, correct data in asset records, add missing data to asset records, add annotation comments pertaining to data in fields of an asset record and/or send communications to sources of information, said communications requesting data regarding an asset which has its attributes recorded in an asset record.

23. The process of claim 21 wherein said user interface correction tools include a markup tool which can be invoked by a user to strike out data in a field of an asset record and show the original data in a strikeout font and add new data to said field, and wherein said markup tool includes a command which can be invoked to accept the proposed changes, said command causing said stricken out data to be removed and the new data to be substituted in said field.

24. The process of claim 21 further comprising presenting user interface tools which can be invoked to create new asset records in said reconciliation database for newly acquired assets.

25. A process comprising:
creating a reconciliation database which stores legacy asset records from one or more first sources and inventory asset records, each collection of asset records having a name;
providing user interface tools which a user can invoke to manually write different, named sets of exact matching rules, each matching rule in a named set having one or more subpart rules each of which can be programmed to compare the contents of a user selected field of an asset record from a user selected set of asset records by a user selected logical operator to the contents of a user selected field of an asset record of a second, user selected set of asset records, and to repeat this process till every combination of asset records from the user selected sets of asset records has been examined, said user interface tools also permitting said user to define a Boolean logical expression which relates how the results of the comparisons defined by said subpart rules are to be combined to determine if an exact match has been found by the exact matching rule composed by said user;
in a first phase, applying a set of exact matching rules to asset records in said reconciliation database to find matches between asset records in said reconciliation database and displaying said matches for confirmation by a user, and, if confirmed, linking the matching records;
in a second phase, applying a set of fuzzy matching rules to asset records not matched in said first phase to find more matches and displaying said matches for confirmation by a user, and, if confirmed, linking the matching records; and
in a third phase, providing user interface tools which can be invoked by a user to compose and run a search based upon criteria suggested by a first asset record in said reconciliation database not matched in said first or second phase to find other asset records which may be a match for said first asset record and providing user interface tools which can be used to select as a match an asset record returned by said search, and if an asset record is selected as a match, linking the matching asset records.

26. The process of claim 25 wherein said multiphase matching process further comprises:
in a fourth phase, providing user interface tools which can be used to browse asset records in said reconciliation database to find asset records in said reconciliation database with missing or incorrect information and correct or add information or annotate an asset record with a note; and
in a fifth phase, providing user interface tools which can be invoked to manually create new asset records in said reconciliation database that define assets which for any reason do not already have an asset record in said reconciliation database,
and wherein said fourth phase includes the step of, at the option of a user, exporting said corrected or annotated asset record back to a legacy computer system to create a corrected asset record therein, or generating a report showing said corrected or annotated asset record for use by an operator of a legacy system in creating corrected asset records in a legacy computer system.

27. The process of claim 25 further comprising the steps of creating a unique signature from attribute data in each of said legacy asset records and each of said inventory asset records and storing said unique signature with each said asset record from which it was generated, and repetitively importing inventory asset records and creating a unique signature from the attribute data of each said inventory asset record and comparing said signature with signatures of inventory asset records already stored in said reconciliation database, and if a matching signature is found, not writing said inventory asset record into said reconciliation database, but if a signature is not found, writing said inventory asset record into said reconciliation database, and repetitively importing asset records from one or more legacy computer systems and mapping attribute data therein into fields of a legacy asset record having the same semantic meaning to create a new legacy asset record, and creating a unique signature from said attribute data of said legacy asset record and comparing said signature with signatures of legacy asset records already stored in said reconciliation database, and if a matching signature is found, not writing said new legacy asset record into said reconciliation database, but if no matching signature is found, writing said new legacy asset record into said reconciliation database, and then repeating the process of said first, second, third, fourth and fifth stages to attempt to find matches.

28. A process comprising:
creating a reconciliation database having legacy asset records stored therein derived from asset records stored in legacy computer systems and inventory asset records;
applying a multiphase matching process to attempt to reconcile said legacy asset records and said inventory asset records by finding matches between legacy asset records and inventory asset records that describe the same asset, said multiphase matching process comprising applying exact matching rules to find a first set of matches and linking the matched records and then applying fuzzy matching rules to asset records not previously matched find matches between records that do not exactly match and linking the matching records so found, and then providing search tools to search for matches for an asset record among asset records not previously matched.

29. The process of claim 28 further comprising providing manual data entry tools to browse asset records and correct complete or annotate asset records in said reconciliation database with incorrect or missing information, and providing tools which can be invoked to create new asset records in said reconciliation database for assets which do not already have asset records in said reconciliation database, and wherein said process of creating a reconciliation database comprises repetitively importing asset records from legacy computer systems and mapping the data in fields of each record into fields of the same semantic meaning in a uniform legacy asset record data structure and creating and using unique signatures for each said asset record to prevent creation of duplicate legacy asset records or duplicate inventory asset records.

30. The process of claim 29 wherein said multiphase matching process includes displaying proposed matches found using said search tools and providing user interface tools to accept user input to select a matching record and link the selected matching record to another asset record which describes the same physical asset, and wherein said process of applying said multiphase matching process comprises repeatedly applying said multiphase matching process over time to unmatched asset records in said reconciliation database which have not been previously been matched and linked together so as to continually attempt to increase the number of asset records in said reconciliation database which have been matched.

31. A computer-readable medium having stored thereon computer-readable instructions which, if executed by a computer cause said computer to implement the following process:
creating a reconciliation database which stores legacy asset records from one or more first sources and inventory asset records from an automated asset discovery process;
in a first phase, applying a set of matching rules to asset records in said reconciliation database to find matches between asset records in said reconciliation database and displaying said matches for confirmation by a user, and, if confirmed, linking the matching records;
in a second phase, applying a set of fuzzy matching rules to asset records not matched in said first phase to find more matches and displaying said matches for confirmation by a user, and, if confirmed, linking the matching records;
in a third phase, providing user interface tools which can be invoked by a user to compose and run a search based upon criteria suggested by a first asset record in said reconciliation database not matched in said first or second phase to find other asset records which may be a match for said first asset record and providing user interface tools which can be used to select as a match an asset record returned by said search, and if an asset record is selected as a match, linking the matching asset records.

32. The computer-readable medium of claim 31 further storing computer-readable instructions which, if executed by a computer, would cause said computer to execute:
a fourth phase, providing user interface search tools which can be used to search for asset records in said reconciliation database to find asset records in said reconciliation database with missing or incorrect information and correct or add information or annotate an asset record with a note; and
a fifth phase, providing user interface editing tools which can be invoked to manually create new asset records in said reconciliation database that define assets which for any reason do not already have an asset record in said reconciliation database said fourth phase by providing user interface tools which can be invoked to provide options to a user to either export said corrected or annotated asset record back to a legacy computer system to create a corrected asset record therein, or generate a report showing said corrected or annotated asset record for use by an operator of a legacy system in creating corrected asset records in a legacy computer system, or both.

33. The computer-readable medium of claim 32 further storing computer-readable instructions which, if executed by a computer, would cause said computer to provide said user interface search tools and editing tools during all phases of said multiphase matching process.

34. A computer-readable medium having stored thereon computer-readable instructions which, if executed by a computer cause said computer to implement the following process:
creating a reconciliation database having legacy asset records stored therein derived from asset records stored in legacy computer systems and inventory asset records from attribute data automatically discovered about assets coupled to a network;
applying a multiphase matching process to attempt to reconcile said legacy asset records and said inventory asset records by finding matches between legacy asset records and inventory asset records that describe the same asset, said multiphase matching process comprising applying exact matching rules to find a first set of matches and linking the matched records and then applying fuzzy matching rules to asset records not previously matched find matches between records that do not exactly match and linking the matching records so found, and then providing search tools to search for matches for an asset record among asset records not previously matched and displaying proposed matches and accepting user input to select a matching record and link the selected record to another asset record which describes the same physical asset, and providing manual data entry tools to browse asset records and correct, complete or annotate asset records in said reconciliation database with incorrect or missing information, and providing tools which can be invoked to create new asset records in said reconciliation database for assets which do not already have asset records in said reconciliation database.

35. The computer readable medium of claim 34 further storing computer-readable instructions which, if executed by a computer, would cause said computer to provide user interface tools which can be invoked to export corrected, annotated or new asset records in said reconciliation database back into asset records in a legacy computer system using a reverse mapping process.

36. An apparatus comprising:
a server having an input device and a network interface circuit and programmed with an operating system and one or more application programs wherein at least one of said application programs cooperates with said operating system to control said server to carry out the following process:
creating a reconciliation database having asset records stored therein derived from asset records stored in legacy computer systems and from attribute data automatically discovered about assets coupled to a network;
applying a multiphase matching process to attempt to reconcile said asset records by finding matches between asset records from different sources that pertain to the same asset, said multiphase matching process comprising applying exact matching rules to find a first set of matches and linking the matched records and then applying fuzzy matching rules to asset records not previously matched find matches between records that do not exactly match and linking the matching records so found, and then providing search tools to search for matches for an asset record among asset records not previously matched.

37. The apparatus of claim 36 wherein said server is further programmed to provide manual data entry tools to browse asset records and correct, complete or annotate asset records in said reconciliation database with incorrect or missing information, and provide tools which can be invoked to create new asset records in said reconciliation database for asset which do not already have asset records in said reconciliation database, and is further programmed to provide user interface tools which can be invoked to provide options to a user to either export said corrected, completed, annotated or new asset record back to a legacy computer system to create a corrected, completed or new asset record therein, or generate a report showing said corrected, completed, annotated or new asset record for use by an operator of a legacy system in creating corrected asset records in a legacy computer system, or both.

38. The apparatus of claim 37 wherein said server is further programmed to display proposed matches found using said search tools and providing user interface tools to which can be invoked by a user to accept user input to select a matching record and link the selected matching asset record to another asset record which describes the same physical asset, and wherein said process of applying said multiphase matching process comprises repeatedly applying said multiphase matching process over time to unmatched asset records in said reconciliation database which have not been previously matched and linked together so as to continually attempt to increase the number of asset records in said reconciliation database which have been matched.

39. An apparatus comprising:
means for importing automatically discovered asset records into a reconciliation database, said automatically discovered asset records at least containing attribute data regarding assets of an entity coupled to networks of said entity;
means for creating legacy asset records in said reconciliation database from asset records stored in legacy computer systems of said entity, said legacy asset records pertaining to assets of said entity;
signature means for preventing duplication of automatically discovered asset records or legacy asset records in said reconciliation database upon subsequent automated asset discovery processes or subsequent importations of asset records from said legacy computer systems;
first phase means for using exact matching rules for reconciling said legacy asset records with said automatically discovered asset records to find and link legacy asset records and automatically discovered asset records which pertain to the same asset;
second phase means for using fuzzy matching rules to examine asset records not matched by said first phase means and display a list of proposed matches for at least some of said unmatched asset records and for receiving operator input selecting a matching record for said unmatched asset record from said displayed list of proposed matches and for linking said matching records so selected;
third phase means for providing user interface tools which can be invoked by a user to search asset records in said reconciliation database for records which match search criteria entered by a user and for displaying asset records which match said search criteria and for receiving user input selecting a displayed asset record as a match for another asset record and for linking said matching asset records; and
fourth phase means for providing user interface tools which can be invoked by a user to browse records in said reconciliation database to locate said legacy asset records and correct or annotate missing or incorrect information therein.

40. The apparatus of claim 39 further comprising means for providing user interface tools which can be invoked by a user to create new asset records in said reconciliation database for assets which have no asset records in said reconciliation database and for reverse mapping said new asset records into asset records in a legacy computer system of said entity.

41. The apparatus of claim 39 further comprising means for providing user interface tools which can be invoked during operation by said first phase means, second phase means, third phase means or fourth phase means by a user to correct and/or annotate asset records in said reconciliation database.

42. The apparatus of claim 39 further comprising means for providing user interface tools which can be invoked during operation by said first phase means, second phase means, third phase means or fourth phase means by a user to correct and/or annotate asset records in said reconciliation database and for providing a function which can be invoked by a user to reverse map the corrected and/or annotated asset record back into an asset record of a legacy computer system.

43. The apparatus of claim 39 further comprising means for providing user interface tools which can be invoked during operation by said first phase means, second phase means, third phase means or fourth phase means by a user to annotate asset records in said reconciliation database to add notes about missing and/or incorrect information and for providing a function which can be invoked by a user to send said annotated record back to some other person employed by said entity for purposes of correcting a corresponding asset record in a legacy computer system.

44. The apparatus of claim 39 further comprising means for providing user interface tools which can be invoked during operation by said first phase means, second phase means, third phase means or fourth phase means by a user to annotate asset records in said reconciliation database to add notes about missing and/or incorrect information and for providing a function which can be invoked by a user to accept all or selected annotated changes and for providing a function which can be invoked to reverse map said annotated asset records back into corrected asset records of a legacy computer system.
